(19) United States
(12) Patent Application Publication
(10) Pub. No.: US 2025/0126268 A1
(43) Pub. Date: Apr. 17, 2025

(54) VIDEO DECODING METHOD AND APPARATUS, VIDEO ENCODING METHOD AND APPARATUS, STORAGE MEDIUM, AND DEVICE

(71) Applicant: Tencent Technology (Shenzhen) Company Limited, Shenzhen (CN)

(72) Inventor: Zizheng Liu, Shenzhen (CN)

(73) Assignee: Tencent Technology (Shenzhen) Company Limited, Shenzhen (CN)

(21) Appl. No.: 18/991,903

(22) Filed: Dec. 23, 2024

Related U.S. Application Data
(63) Continuation of application No. PCT/CN2023/106439, filed on Jul. 7, 2023.

(30) Foreign Application Priority Data
Oct. 11, 2022 (CN) 202211263583.8

(51) Int. Cl. H04N 19/132; H04N 19/146; H04N 19/172

(52) U.S. Cl. CPC H04N 19/132; H04N 19/146; H04N 19/172

(57) ABSTRACT

A video encoding method, performed by a computer device, includes: obtaining a media application scenario and a video content feature of original video data to be encoded; determining a target sampling parameter based on the media application scenario and the video content feature; sampling the original video data based on the target sampling parameter, to obtain sampled video data; encoding the sampled video data, to obtain encoded video data corresponding to the original video data; and transmitting at least one of the encoded video data or the target sampling parameter.

### CROSS REFERENCE TO RELATED APPLICATIONS

This application is a continuation application of International Application No. PCT/CN2023/106439 filed on Jul. 7, 2023, which claims priority to Chinese Patent Application No. 202211263583.8 filed with the China National Intellectual Property Administration on Oct. 11, 2022, the disclosures of each being incorporated by reference herein in their entireties.

### FIELD

This application relates to the field of data processing technologies, and in particular, to a video decoding method and apparatus, a video encoding method and apparatus, a storage medium, a device, and a computer program product.

### BACKGROUND

With the development of digital media technologies and computer technologies, videos may be applied to various fields such as mobile communication, network recognition, and network television, which may bring great convenience for entertainment and to the lives of people. Under a condition of a limited bandwidth, however, current encoders may encode a video frame, which may cause a large amount of redundant information to be included in a video bitstream, which may affect performance and may provide poor encoding efficiency of video data.

### SUMMARY

Provided are a video decoding method and apparatus, a video encoding method and apparatus, a storage medium, a device, and a computer program product.

According to some embodiments, a video encoding method, performed by a computer device, includes: obtaining a media application scenario and a video content feature of original video data to be encoded; determining a target sampling parameter based on the media application scenario and the video content feature; sampling the original video data based on the target sampling parameter, to obtain sampled video data; encoding the sampled video data, to obtain encoded video data corresponding to the original video data; and transmitting at least one of the encoded video data or the target sampling parameter.

According to some embodiments, a video encoding apparatus includes: at least one memory configured to store computer program code; and at least one processor configured to read the program code and operate as instructed by the program code, the program code including: obtaining code configured to cause at least one of the at least one processor to obtain a media application scenario and a video content feature of original video data to be encoded; determining code configured to cause at least one of the at least one processor to determine a target sampling parameter based on the media application scenario and the video content feature; sampling code configured to cause at least one of the at least one processor to sample the original video data based on the target sampling parameter, to obtain sampled video data; encoding code configured to cause at least one of the at least one processor to encode the sampled video data, to obtain encoded video data corresponding to the original video data; and transmitting code configured to cause at least one of the at least one processor to transmit at least one of the encoded video data or the target sampling parameter.

According to some embodiments, a non-transitory computer-readable storage medium, storing computer code which, when executed by at least one processor, causes the at least one processor to at least: obtain a media application scenario and a video content feature of original video data to be encoded; determine a target sampling parameter based on the media application scenario and the video content feature; sample the original video data based on the target sampling parameter, to obtain sampled video data; encode the sampled video data, to obtain encoded video data corresponding to the original video data; and transmit at least one of the encoded video data or the target sampling parameter.

### BRIEF DESCRIPTION OF THE DRAWINGS

To describe the technical solutions of some embodiments of this disclosure more clearly, the following briefly introduces the accompanying drawings for describing some embodiments. The accompanying drawings in the following description show only some embodiments of the disclosure, and a person of ordinary skill in the art may still derive other drawings from these accompanying drawings without creative efforts. In addition, one of ordinary skill would understand that aspects of some embodiments may be combined together or implemented alone.

FIG. 1 is a schematic diagram of a video data processing process according to some embodiments.

FIG. 2 is a schematic diagram of a coding unit according to some embodiments.

FIG. 3 is a schematic flowchart of a video encoding method according to some embodiments.

FIG. 4 is a schematic diagram of a temporal sampling mode according to some embodiments.

FIG. 5 is a schematic diagram of a spatial sampling mode according to some embodiments.

FIG. 6 is a schematic diagram of a video decoding method according to some embodiments.

FIG. 7 is a schematic structural diagram of a video decoding apparatus according to some embodiments.

FIG. 8 is a schematic structural diagram of a video encoding apparatus according to some embodiments.

FIG. 9 is a schematic structural diagram of a computer device according to some embodiments.

FIG. 10 is a schematic structural diagram of a computer device according to some embodiments.

### DESCRIPTION OF EMBODIMENTS

To make the objectives, technical solutions, and advantages of the present disclosure clearer, the following further describes the present disclosure in detail with reference to the accompanying drawings. The described embodiments are not to be construed as a limitation to the present disclosure. All other embodiments obtained by a person of ordinary skill in the art without creative efforts shall fall within the protection scope of the present disclosure.

In the following descriptions, related “some embodiments” describe a subset of all possible embodiments. However, it may be understood that the “some embodiments” may be the same subset or different subsets of all the possible embodiments, and may be combined with each other without conflict. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. For example, the phrase “at least one of A, B, and C” includes within its scope “only A”, “only B”, “only C”, “A and B”, “B and C”, “A and C” and “all of A, B, and C.”

The disclosure includes solutions in the field of cloud technologies. Cloud computing is a computing mode, in which computing tasks are distributed on a resource pool formed by a large quantity of computers, so that various application systems can obtain computing power, storage space, and information services according to requirements. A network that provides resources is referred to as a “cloud”. For a user, resources in a “cloud” seem to be infinitely expandable, and can be obtained readily, used on demand, and expanded readily. Video data may be encoded and decoded through cloud computing.

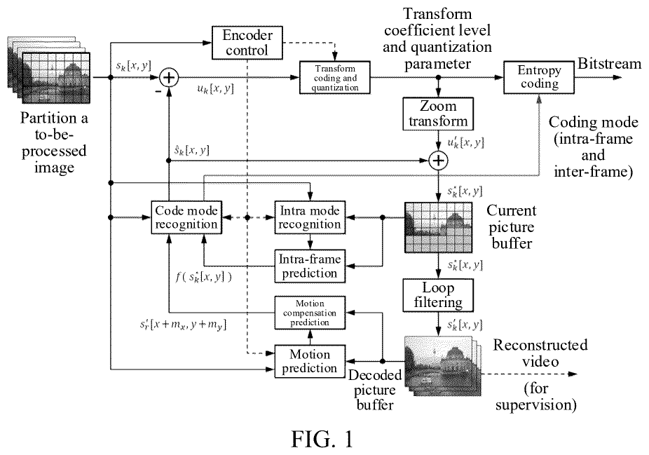

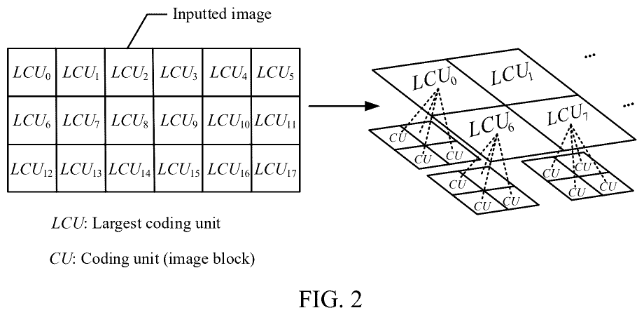

Some embodiments relate to a video data processing technology. Video data processing may include: video collection, video encoding, video file encapsulation, video transmission, video file decapsulation, video decoding, and final video presentation. The video collection may be configured for converting an analog video into a digital video and storing the digital video in a digital video file format, for example, a video signal may be converted into binary digital information through video collection. Binary information converted from the video signal is a binary data flow. The binary information may also be referred to as a bitstream of the video signal. The video encoding is to convert a file in an original video format into a file in another video format by using a compression technology. Generation of video media content described in some embodiments includes a real scene generated through camera collection and a screen content scene generated by a computer. A mode of obtaining a video signal may include two modes of photographing by a camera and generating by a computer. Due to different statistical characteristics, compression coding modes corresponding to the modes may be different. In modern mainstream video coding technologies, for example, international video coding standards such as high efficiency video coding (HEVC/H.265) and versatile video coding (VVC/H.266), and video coding standards such as audio video coding standard (AVS), or AV3 (which is a third generation video coding standard pushed by an AVS standard set), a series of operations and processing are performed on an inputted raw video signal by using a hybrid coding framework. As shown in FIG. 1, FIG. 1 is a schematic diagram of a video data processing process according to some embodiments. Content is shown in FIG. 1.
1. Block partition structure: An inputted image (for example, a video frame in video data) is partitioned into a plurality of non-overlapping processing units according to a size. Similar compression operations are performed on each processing unit. The processing unit is referred to as a coding tree unit (CTU) or a largest coding unit (LCU). The coding tree unit may be divided from the largest coding unit. The CTU may continue to be further partitioned to obtain one or more basic coding units, referred to as coding units (CUs). Each CU is a basic element in an encoding process. Various coding modes that may be configured for each CU are described below. As shown in FIG. 2, FIG. 2 is a schematic diagram of a coding unit according to some embodiments. A relationship between an LCU (or a CTU) and a CU may be shown in FIG. 2.
2. Predictive coding includes an intra-frame prediction mode, an inter-frame prediction mode, and the like. A residual video signal is obtained based on prediction of a raw video signal through a selected reconstructed video signal. An encoder side may select a predictive coding mode for a current CU from a plurality of predictive coding modes, and inform a decoder side.
a. Intra-frame prediction (intra (picture) prediction): Predicted signals are from an encoded reconstructed region of a same image.
b. Inter-frame prediction (inter (picture) prediction) refers to that a predicted signal is from another encoded image (referred to as a reference image) different from a current image.
3. Transform&quantization: Transform operations such as discrete fourier transform (DFT) and discrete cosine transform (DCT, which is a subset of the DFT) are performed on a residual video signal to convert the signal into a transform domain, which is referred to as a conversion coefficient. A lossy quantization operation is further performed on a signal in the transform domain, and information may be discarded, so that a quantized signal is readily available for compression and expression.

In some video coding standards, there may be more than one transform modes for selection. Therefore, the encoder side may select one transform mode for the current CU and informs the decoder side of the mode. Fineness of the quantization may be determined by a quantization parameter (QP). A larger QP indicates that coefficients with a larger value range are to be quantized into a same output, which may bring greater distortion and a lower bit rate. On the contrary, a smaller QP indicates that coefficients within a smaller value range are to be quantized into a same output, which may bring less distortion and a higher bit rate.
4. Entropy coding or statistical coding: Statistical compression coding is performed on a quantized transform domain signal according to a frequency of each value, and finally a binary (0 or 1) compressed bitstream is outputted. In addition, other information such as a selected mode and a motion vector generated through coding may also use entropy coding to reduce a bit rate.

Statistical coding is a lossless coding mode that may reduce a bit rate for expressing a same signal. Statistical coding modes may include variable length coding (VLC) or content adaptive binary arithmetic coding (CABAC).
5. Loop filtering: A reconstructed decoded image may be obtained by performing operations such as inverse quantization, inverse transform, and predictive compensation (inverse operations of 2 to 4 in the foregoing) on an encoded image. Compared with a raw image, in a reconstructed image, some information may be different from that in the raw image due to the impact of quantization, causing a distortion. A filtering operation may be performed on the reconstructed image by using a deblocking filter, a sample adaptive offset (SAO) filter, an adaptive loop filter (ALF), or the like, to reduce a degree of distortion caused by quantization. Because the filtered reconstructed image is used as a reference for encoding an image and is used for predicting a future signal, the foregoing filtering operation is also referred to as loop filtering, for example, a filtering operation in an encoding loop.

FIG. 1 shows a basic procedure of a video encoder. A k^{th} CU (which is denoted as Sₖ[x, y]) is used as an example for description in FIG. 1, where k is a positive integer greater than or equal to 1 and less than or equal to a quantity of CUs in an inputted current image, Sₖ[x, y] represents a pixel with coordinates of [x, y] in the k^{th} CU, x represents a horizontal coordinate of the pixel, y represents a vertical coordinate of the pixel. Based on processing of motion compensation or intra-frame prediction is performed on Sₖ[x, y], a predicted signal Ŝₖ[x, y] is obtained. Sₖ[x, y] is subtracted from Ŝₖ[x, y] to obtain a residual signal Uₖ[x, y], and transform and quantization are performed on the residual signal Uₖ[x, y]. Quantized outputted data has two different destinations: One is that the data is transmitted to an entropy encoder for entropy coding, and an encoded bitstream is outputted to a buffer for storage and waits for transmission. The other is that dequantization and inverse transform are performed on the data, to obtain a signal U′ₖ[x, y]. The signal U′ₖ[x y] is added to Ŝₖ[x, y] to obtain a new predicted signal S*ₖ[x, y], and S*ₖ[x, y] is transmitted to a buffer of a current image for storage. Intra-image prediction is performed on S*ₖ[x, y], to obtain f(S*ₖ[x, y]). Loop filtering is performed on S*ₖ[x, y], to obtain S′ₖ[x, y], and S′ₖ[x, y] is transmitted to a buffer of a decoded image for storage, to generate a reconstructed video. Motion-compensation prediction is performed on S′ₖ[x, y] to obtain S′ᵣ[x+mₓ, y+m_{y}]. S′ᵣ[x+mₓ, y+m_{y}] represents a reference block. mₓ and m_{y} respectively represent a horizontal component and a vertical component of a motion vector.

Based on the video data being encoded, a data flow obtained through encoding may be encapsulated and transmitted to a user. The video file encapsulation means that encoded and compressed video and audio are stored in a file in an encapsulation format (or container, or file container). Encapsulation formats may include an audio video interleaved (AVI) format, or an ISO based media file format (ISOBMFF, which is a media file format based on international standard organization (ISO)). The ISOBMFF is an encapsulation standard of a media file. An ISOBMFF file may be a moving picture experts group 4 (MP4) file. An encapsulated file is transmitted to a decoding device through a video. Based on the decoding device performing inverse operations such as decapsulation and decoding, final video content presentation may be performed in the decoding device.

A file decapsulation process of the decoding device is opposite to the file encapsulation process. The decoding device may perform decapsulation on the encapsulated file according to a file format requirement during encapsulation, to obtain a video bitstream. A decoding process of the decoding device is also opposite to the encoding process. The decoding device may decode the video bitstream, to restore video data. According to the foregoing encoding process, on a decoder side, based on obtaining a compressed bitstream, for each CU, a decoder first performs entropy decoding to obtain various mode information and quantized transform coefficients. Inverse quantization and inverse transform are performed on the coefficients, to obtain a residual video signal. In addition, a predicted signal corresponding to the CU may be obtained according to the known encoding mode information, and a reconstructed signal may be obtained by adding the residual video signal and the predicted signal. Finally, a loop filtering operation may be performed on a reconstructed value of a decoded image, to generate a final output signal.

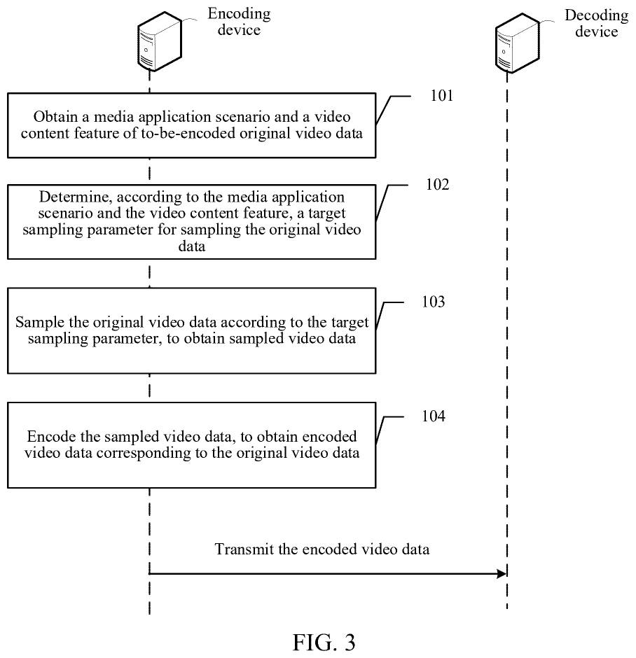

As shown in FIG. 3, FIG. 3 is a schematic flowchart of a video encoding method according to some embodiments. The method may be performed by a computer device. The computer device may be an encoding device. As shown in FIG. 3, the method may include, but not limited to, the following operations.
101: Obtain a media application scenario and a video content feature of to-be-encoded original video data.

Based on obtaining to-be-encoded original video data, the encoding device may obtain a media application scenario of the original video data. The media application scenario may include a user viewing scenario, a machine recognition scenario, and the like. The user viewing scenario is a scenario in which a target user views video data. The machine recognition scenario may include a scenario in which a machine determines video data and completes a related task (for example, a detection task or a recognition task). Video perceptual features of a target object for video data are different in different media application scenarios, for example, a video perceptual feature of a target user for video data in the user viewing scenario is different from a video perceptual feature of a target machine for the video data in the machine recognition scenario. Therefore, a quality and a resolution of the video data in the user viewing scenario may be different from a quality and a resolution of the video data in the machine recognition scenario, and different encoding methods may be used in different media application scenarios to meet requirements of corresponding scenarios. The encoding device may also obtain a video content feature of the original video data. The video content feature may include a video content change rate and a video content information amount of the original video data, a video resolution of a video frame in the original video data, a quantity of video frames played in unit time in the original video data, and the like.
102: Determine, according to the media application scenario and the video content feature, a target sampling parameter for sampling the original video data.

The media application scenario may reflect a quality requirement (for example, a content change rate requirement and a resolution requirement) of video data for the target object. The video content feature of the original video data may reflect the video content change rate and the video content information amount of the original video data. The encoding device may determine, according to the media application scenario and the video content feature, a target sampling parameter for sampling the original video data. The target sampling parameter may include a target sampling mode and a target sampling rate in the target sampling mode. The target sampling mode may include a temporal sampling mode and a spatial sampling mode. The temporal sampling mode is to perform video frame sampling on video data, and the spatial sampling mode is to sample a video resolution of the video data. The target sampling rate in the target sampling mode may include a target sampling rate in the temporal sampling mode and a target sampling rate in the spatial sampling mode. For example, the target sampling rate in the temporal sampling mode may refer to extracting a frame at a rate of 2 (for example, sampling one frame every one frame), extracting a frame at a rate of 3 (for example, sampling one frame every two frames), and the like. For example, the target sampling rate in the spatial sampling mode may be any value greater than 0, for example, 0.5 times (for example, a resolution is reduced by 0.5 times), 0.75 times (for example, a resolution is reduced by 0.75 times), or 2 times (for example, a resolution is reduced by 2 times).

In some embodiments, a manner in which the encoding device determines the target sampling parameter for sampling the original video data may include: determining, according to the video content feature, a target sampling mode for sampling the original video data; determining a video perceptual feature of a target object for video data in the media application scenario, where the target object is an object that perceives the original video data; determining a target sampling rate in the target sampling mode according to the video perceptual feature and the video content feature; and determining the target sampling rate and the target sampling mode as the target sampling parameter for sampling the original video data.

The encoding device may determine, according to the video content feature, a target sampling mode for sampling the original video data. The target sampling mode of the original video data can be adaptively determined, and accuracy of sampling the original video data can be improved. The encoding device may determine a video perceptual feature of a target object for video data in the media application scenario of the original video data. The target object is an object that perceives the original video data. The video perceptual feature may be configured for reflecting information such as a quality requirement and a resolution requirement of the target object for the video data. Further, the encoding device may determine a target sampling rate in the target sampling mode according to the video perceptual feature and the video content feature and determine the target sampling rate and the target sampling mode as the target sampling parameter for sampling the original video data. The target sampling mode and the target sampling rate in the target sampling mode are adaptively determined according to the media application scenario and the video content feature, so that the accuracy of sampling the original video data can be improved, that application (for example, user viewing or machine recognition) of the original video data may not be affected based on a decoding device restoring the original video data according to encoded video data, and a data amount of the encoded video data obtained by encoding the original video data can be further reduced. Based on the original video data being sampled by using the target sampling parameter, the decoding device may restore viewing quality of the original video data according to the encoded video data, and the data amount of the encoded video data may be reduced.

The target sampling mode may include a temporal sampling mode, a spatial sampling mode, and one of the temporal sampling mode and the spatial sampling mode. The temporal sampling mode is to perform frame extraction sampling on the original video data, and the spatial sampling mode is to sample a video resolution of the original video data. A target sampling rate in the temporal sampling mode is a ratio of a quantity of extracted video frames to a quantity of original video frames based on frame extraction sampling being performed on the original video data. A target sampling rate in the spatial sampling mode is a ratio of a video resolution obtained through sampling to an original video resolution based on the video resolution of the original video data being sampled.

In some embodiments, a manner in which the encoding device determines the target sampling mode may include: determining a repetition rate of video content in the original video data according to a video content change rate included in the video content feature; and determining, according to the repetition rate of the video content in the original video data, the target sampling mode for sampling the original video data.

The video content feature includes a video content change rate (for example, a change rate of picture content in a video) of the original video data. The video content change rate may be a moving speed of a movable object in video content, a change rate of a pixel in the video content, or the like. The encoding device may determine a repetition rate of video content in the original video data according to the video content change rate of the original video data. The repetition rate may be a repetition rate between any two video frames that are adjacent in a play sequence in the original video data. Further, the encoding device may determine, according to the repetition rate of the video content in the original video data, the target sampling mode for sampling the original video data. For example, based on the repetition rate of the video content in the original video data being excessively low, frame extraction sampling may not be performed on the original video data. If frame extraction sampling is performed on the original video data, a display effect of the original video data restored by the decoding device according to the encoded video data is affected (for example, problems that video content is incoherent, the video content has great jumpy, and the like occur). The target sampling mode is determined according to the repetition rate of the video content in the original video data, so that accuracy of the target sampling mode can be improved, without the display effect of the original video data restored by the decoding device according to the encoded video data being affected, and a data amount of the encoded video data obtained by encoding the original video data can be reduced.

In some embodiments, a manner in which the encoding device determines the target sampling mode according to the repetition rate may include: if the repetition rate of the video content in the original video data is greater than a first repetition rate threshold, determining a temporal sampling mode and a spatial sampling mode as the target sampling mode for sampling the original video data; if the repetition rate of the video content in the original video data is less than or equal to the first repetition rate threshold and greater than a second repetition rate threshold, determining the temporal sampling mode as the target sampling mode for sampling the original video data, where the second repetition rate threshold is less than the first repetition rate threshold; and if the repetition rate of the video content in the original video data is less than or equal to the second repetition rate threshold, determining the spatial sampling mode as the target sampling mode for sampling the original video data. The first repetition rate threshold and the second repetition rate threshold may be set according to a perception requirement of the target object or may be set according to a situation. The first repetition rate threshold and the second repetition rate threshold are not limited.

If the encoding device determines that the repetition rate of the video content in the original video data is greater than a first repetition rate threshold, temporal sampling and spatial sampling on the original video data may not affect a display effect of the sampled video data obtained through sampling. Therefore, the temporal sampling mode and the spatial sampling mode may be determined as the target sampling mode for sampling the original video data. The data amount of the encoded video data obtained by encoding the original video data can be greatly reduced. If the encoding device determines that the repetition rate of the video content in the original video data is less than or equal to the first repetition rate threshold and greater than a second repetition rate threshold, the encoding device may determine the temporal sampling mode as the target sampling mode for sampling the original video data. The second repetition rate threshold is less than the first repetition rate threshold. The original video data is sampled by using only the temporal sampling mode, so that the data amount of the encoded video data of the original video data can be reduced, and a case in which temporal sampling is performed on the original video data by using the temporal sampling mode and the spatial sampling mode, a large amount of information about the sampled video data obtained through sampling is lost, and the display effect of the original video data restored according to the sampled video data obtained through sampling is further affected may be avoided.

If the encoding device determines that the repetition rate of the video content in the original video data is less than or equal to the first repetition rate threshold and greater than the second repetition rate threshold, the encoding device may determine the spatial sampling mode as the target sampling mode for sampling the original video data. If the repetition rate of the video content in the original video data is less than or equal to the first repetition rate threshold and greater than the second repetition rate threshold, any one of the temporal sampling mode and the spatial sampling mode may be used as the target sampling mode for sampling the original video data. If the encoding device determines that the repetition rate of the video content in the original video data is less than or equal to the second repetition rate threshold, a large amount of information is lost if the original video data is sampled by using the temporal sampling mode, so that the spatial sampling mode may be determined as the target sampling mode for sampling the original video data. A suitable target sampling mode can be determined according to the repetition rate of the video content in the original video data, thereby improving sampling accuracy. The manner in which the encoding device determines the target sampling mode according to the repetition rate is applicable to a video frame in the original video data. For example, a target sampling mode for sampling a current video frame is determined according to a repetition rate between the current video frame and a reference video frame (which may be a video frame whose play sequence is a previous frame of the current video frame, or a video frame whose play sequence is a next frame of the current video frame) in the original video data.

In some embodiments, a manner in which the encoding device determines the target sampling mode may further include: determining complexity of video content in the original video data according to a video content information amount included in the video content feature; and determining, according to the complexity of the video content in the original video data, the target sampling mode for sampling the original video data.

In some embodiments, the video content feature of the original video data includes a video content information amount. The video content information amount may reflect complexity of content in the original video data, for example, a larger video content information amount of the original video data may indicate more complex video content. A smaller video content information amount of the original video data may indicate less complex video content. For example, more scenes and pictures involved in the video content indicate a larger amount of information included in the video content. For example, a video picture of a sports field may include a plurality of person scenes, and a video content information amount is high. A video picture of a single scene such as a sea or a lake includes relatively single elements, and a video content information amount is low. For another example, both a video A and a video B include texts. If a text font is smaller and a text amount is larger in the video A than in the video B, a video content information amount of the video A is higher. The encoding device may determine complexity of video content in the original video data according to the video content information amount included in the video content feature of the original video data. Further, the encoding device may determine, according to the complexity of the video content in the original video data, the target sampling mode for sampling the original video data. For example, if the complexity of the video content in the original video data is relatively high, information of the original video data may be lost due to use of the spatial sampling mode, resulting in confused video content in the sampled video data obtained through sampling. The spatial sampling mode may not be configured for sampling the original video data. The target sampling mode for sampling the original video data is determined according to the complexity of the video content in the original video data, so that a suitable target sampling mode can be determined, thereby improving sampling accuracy. The manner in which the encoding device determines the target sampling mode according to the complexity is applicable to a video frame in the original video data. For example, a target sampling mode for sampling a current video frame is determined according to complexity of the current video frame in the original video data.

In some embodiments, a manner in which the encoding device determines the target sampling mode according to the complexity may include: if the complexity of the video content in the original video data is greater than a first complexity threshold, determining a temporal sampling mode and a spatial sampling mode as the target sampling mode for sampling the original video data; if the complexity of the video content in the original video data is greater than or equal to the first complexity threshold and less than a second complexity threshold, determining the spatial sampling mode as the target sampling mode for sampling the original video data, where the second complexity threshold is greater than the first complexity threshold; if the complexity of the video content in the original video data is greater than the second complexity threshold, determining the temporal sampling mode as the target sampling mode for sampling the original video data. The first complexity threshold and the second complexity threshold may be set according to a perception requirement of the target object or may be set according to a situation. The first complexity threshold and the second complexity threshold are not limited.

If the encoding device determines that the complexity of the video content in the original video data is less than the first complexity threshold, the original video data may be sampled by using the temporal sampling mode and the spatial sampling mode, without affecting the display effect of the original video data restored by the decoding device according to the sampled video data obtained through sampling. In addition, the data amount of the encoded video data can also be greatly reduced. If the complexity of the video content in the original video data is greater than or equal to the first complexity threshold and less than the second complexity threshold, the spatial sampling mode is determined as the target sampling mode for sampling the original video data. The second complexity threshold is greater than the first complexity threshold. The original video data is sampled by using the spatial sampling mode, so that the data amount of the encoded video data corresponding to the original video data can be reduced. Based on temporal sampling being performed on the original video data by using the temporal sampling mode and the spatial sampling mode, information about the sampled video data obtained through sampling may be lost, and the display effect of the original video data restored according to the sampled video data obtained through sampling may be avoided.

If the complexity of the video content in the original video data is greater than or equal to the first complexity threshold and less than the second complexity threshold, the temporal sampling mode may be determined as the target sampling mode for sampling the original video data. If the complexity of the video content in the original video data is greater than or equal to the first complexity threshold and less than the second complexity threshold, any one of the temporal sampling mode and the spatial sampling mode may be used as the target sampling mode for sampling the original video data. Further, if the complexity of the video content in the original video data is greater than the second complexity threshold, the complexity of the video content in the original video data is relatively high, information of the original video data may be lost due to use of the spatial sampling mode, resulting in confused video content in the sampled video data obtained through sampling. The spatial sampling mode may not be configured for sampling the original video data, and the temporal sampling mode may be determined as the target sampling mode for sampling the original video data.

In some embodiments, a manner in which the encoding device determines the target sampling mode may include: The encoding device may determine a repetition rate of video content in the original video data according to a video content change rate included in the video content feature, and determine complexity of video content in the original video data according to a video content information amount included in the video content feature. Further, the encoding device may determine, according to the repetition rate of the video content in the original video data and the complexity of the video content in the original video data, the target sampling mode for sampling the original video data. The encoding device may detect, according to the repetition rate of the video content in the original video data, whether to sample the original video data by using the temporal sampling mode, and detect, according to the complexity of the video content in the original video data, whether to sample the original video data by using the spatial sampling mode. If the repetition rate of the video content in the original video data is greater than a third repetition rate threshold, the temporal sampling mode is used as the target sampling mode for sampling the original video data. If the repetition rate of the video content in the original video data is less than or equal to the third repetition rate threshold, the temporal sampling mode is prohibited from being used as the target sampling mode for sampling the original video data. If the complexity of the video content in the original video data is less than a third complexity threshold, the spatial sampling mode is used as the target sampling mode for sampling the original video data. If the complexity of the video content in the original video data is greater than or equal to the third complexity threshold, the temporal sampling mode is prohibited from being used as the target sampling mode for sampling the original video data. The third repetition rate threshold may be set according to a perception requirement of the target object or may be set according to a situation. The third repetition rate threshold is not limited. The third complexity threshold may be set according to a perception requirement of the target object or may be set according to a situation. The third complexity threshold is not limited.

In some embodiments, a manner in which the encoding device determines the target sampling rate in the target sampling mode may include: if the target sampling mode is a temporal sampling mode, determining, according to the video perceptual feature, a limited quantity of video frames that correspond to the video data and that are perceived by the target object in unit time; and determining a target sampling rate in the temporal sampling mode according to a ratio of the limited quantity of video frames to a quantity of played video frames, where the quantity of played video frames represents a quantity of video frames that are played in the unit time in the original video data and that are indicated by the video content feature.

If the encoding device determines to sample the original video data by using the temporal sampling mode, the encoding device may determine, according to the video perceptual feature, a limited quantity of video frames of the video data that are perceived by the target object in unit time. The unit time may be per second, per minute, or the like. A quantity of video frames that can be perceived by a user or a machine in unit time is limited. For example, a video frame rate that can be perceived by eyes of the user is 55 frames/second. Human eyes cannot see a difference between a video whose frame rate exceeds 55 frames/second and a video whose frame rate is 55 frames/second. Based on the frame rate being excessively small, the human eyes can find a problem that a picture of a video whose frame rate is excessively small is not smooth. Because different objects have different video perceptual features, limited quantities of video frames corresponding to different objects are different. The limited quantity of video frames of the video data that are perceived by the target object in the unit time may be less than or equal to a video frame rate that can be perceived by the target object. The limited quantity of video frames may be a minimum quantity of frames that meet a perception requirement of the target object. The encoding device may determine, according to the video perceptual feature and the video content feature of the original video data, the limited quantity of video frames of the video data that are perceived by the target object in the unit time. Based on original video data being sampled according to the limited quantity of video frames to obtain sampled video data, the original video data whose both video quality and resolution meet the perception requirement of the target object may be restored according to the sampled video data.

Further, a quantity of played video frames represents a quantity of video frames that are played in the unit time in the original video data and that are indicated by the video content feature. The encoding device may determine a target sampling rate in the temporal sampling mode according to a ratio of the limited quantity of video frames to the quantity of video frames that are played in the unit time in the original video data and that are indicated by the video content feature. A sampling rate for sampling a video frame may be a positive integer. Therefore, the encoding device may obtain a ratio of the limited quantity of video frames to the quantity of video frames that are played in the unit time in the original video data and that are indicated by the video content feature, and if the ratio is a positive integer, the ratio is determined as the target sampling rate in the temporal sampling mode. If the ratio is not a positive integer, rounding processing is performed on the ratio, to obtain a rounded ratio, and the rounded ratio is determined as the target sampling rate in the temporal sampling mode. Limited quantities of video frames that can be perceived by different target objects are different, and the target sampling rate in the temporal sampling mode is adaptively determined according to the limited quantity of video frames corresponding to the target object, so that when the original video data is restored according to the sampled video data obtained through sampling, quality and a resolution of the restored original video data can meet the perception requirement of the target object.

In some embodiments, a manner in which the encoding device determines the target sampling rate in the target sampling mode according to the video perceptual feature and the video content feature may include: if the target sampling mode is a spatial sampling mode, determining, according to the video perceptual feature, a limited video resolution associated with the target object; and determining a ratio of the limited video resolution to a video frame resolution as a target sampling rate in the spatial sampling mode, where the video frame resolution represents a video resolution that is of a video frame in the original video data and that is indicated by the video content feature.

If the target sampling mode is a spatial sampling mode, the encoding device may determine, according to the video perceptual feature, a limited video resolution associated with the target object. Limited video resolutions associated with different target objects are different. The limited video resolution may be a lowest resolution that meets the perception requirement of the target object. A video resolution for a user (for example, human eyes) when viewing video data and a video resolution for a machine when processing a recognition task may be different. Because the video data may be directed toward a rich display effect, a video resolution for the video may be relatively high. Based on processing the recognition task, the machine may recognize related information of a to-be-recognized object, so that a video resolution may be relatively low. Further, a video frame resolution represents a video resolution that is of a video frame in the original video data and that is indicated by the video content feature. The encoding device may determine a ratio of the limited video resolution to the video resolution that is of the video frame in the original video data and that is indicated by the video content feature as a target sampling rate in the spatial sampling mode. Limited video resolutions for different target objects may be different, and the target sampling rate in the spatial sampling mode is adaptively determined according to the limited video resolution of the target object, so that when the original video data is restored according to the sampled video data obtained through sampling, quality and a resolution of the restored original video data can meet the perception requirement of the target object.

In some embodiments, a manner in which the encoding device determines the target sampling rate in the target sampling mode according to the video perceptual feature and the video content feature may include: if the target sampling mode is a temporal sampling mode and a spatial sampling mode, determining, according to the video perceptual feature, a limited quantity of video frames that correspond to the video data and that are perceived by the target object in unit time, and determining a limited video resolution associated with the target object; determining a target sampling rate in the temporal sampling mode according to a ratio of the limited quantity of video frames to a quantity of played video frames, where the quantity of played video frames represents a quantity of video frames that are played in the unit time in the original video data and that are indicated by the video content feature; and determining a ratio of the limited video resolution to a video frame resolution as a target sampling rate in the spatial sampling mode, where the video frame resolution represents a video resolution that is of a video frame in the original video data and that is indicated by the video content feature.

If the target sampling mode is a temporal sampling mode and a spatial sampling mode, the encoding device may determine, according to the video perceptual feature, a limited quantity of video frames of video data that are perceived by the target object in unit time. Because different objects have different video perceptual features, limited quantities of video frames corresponding to different objects are different. Further, the encoding device may determine a target sampling rate in the temporal sampling mode according to a ratio of the limited quantity of video frames to a quantity of video frames that are played in the unit time in the original video data and that are indicated by the video content feature. A sampling rate for sampling a video frame may be a positive integer. Therefore, the encoding device may obtain a ratio of the limited quantity of video frames to the quantity of video frames that are played in the unit time in the original video data and that are indicated by the video content feature, and if the ratio is a positive integer, the ratio is determined as the target sampling rate in the temporal sampling mode. If the ratio is not a positive integer, rounding processing is performed on the ratio, to obtain a rounded ratio, and the rounded ratio is determined as the target sampling rate in the temporal sampling mode. Limited quantities of video frames that can be perceived by different target objects are different, and the target sampling rate in the temporal sampling mode is adaptively determined according to the limited quantity of video frames corresponding to the target object, so that when the original video data is restored according to the sampled video data obtained through sampling, quality and a resolution of the restored original video data can meet the perception requirement of the target object.

Further, the encoding device may determine, according to the video perceptual feature, a limited video resolution associated with the target object. Limited video resolutions associated with different target objects are different. The limited video resolution may be a lowest resolution that meets the perception requirement of the target object. The encoding device may determine a ratio of the limited video resolution to a video resolution that is of a video frame in the original video data and that is indicated by the video content feature as the target sampling rate in the spatial sampling mode. Limited video resolutions for different target objects may be different, and the target sampling rate in the spatial sampling mode is adaptively determined according to the limited video resolution of the target object, so that when the original video data is restored according to the sampled video data obtained through sampling, quality and a resolution of the restored original video data can meet the perception requirement of the target object.
103: Sample the original video data according to the target sampling parameter, to obtain sampled video data.

The encoding device may sample the original video data according to the target sampling parameter, to obtain sampled video data. The target sampling parameter includes the target sampling mode and the target sampling rate in the target sampling mode. The encoding device may sample the original video data according to the target sampling mode and the target sampling rate in the target sampling mode, to obtain the sampled video data. The original video data is sampled, to obtain the sampled video data, and the sampled video data is encoded to obtain encoded video data corresponding to the original video data, so that a data amount of the encoded video data can be reduced, thereby improving transmission efficiency of the encoded video data and reducing storage space of the encoded video data.

In some embodiments, a manner in which the encoding device samples the original video data according to the target sampling parameter, to obtain the sampled video data may include: if the target sampling mode is a temporal sampling mode, obtaining a play sequence number of a video frame in the original video data and a total video frame quantity of video frames included in the original video data; determining, according to a target sampling rate in the temporal sampling mode and the total video frame quantity, a quantity of to-be-extracted video frames in the original video data as a first video frame quantity; and extracting the first video frame quantity of video frames from the original video data according to the play sequence number of the video frame in the original video data as the sampled video data.

If the target sampling mode is a temporal sampling mode, the encoding device may obtain a play sequence number of a video frame in the original video data and a total video frame quantity of video frames included in the original video data. The encoding device determines, according to a target sampling rate in the temporal sampling mode and the total video frame quantity, a quantity of to-be-extracted video frames in the original video data as a first video frame quantity. The encoding device may obtain a ratio of the total video frame quantity to the target sampling rate in the temporal sampling mode (for example, the total video frame quantity/the target sampling rate in the temporal sampling mode) and use the ratio as the first video frame quantity. For example, the total video frame quantity of video frames included in the original video data is 100 frames, and the target sampling rate in the temporal sampling mode is 2, so that the first video frame quantity is 100/2=50. Further, the encoding device may extract the first video frame quantity of video frames from the original video data according to the play sequence number of the video frame in the original video data as the sampled video data.

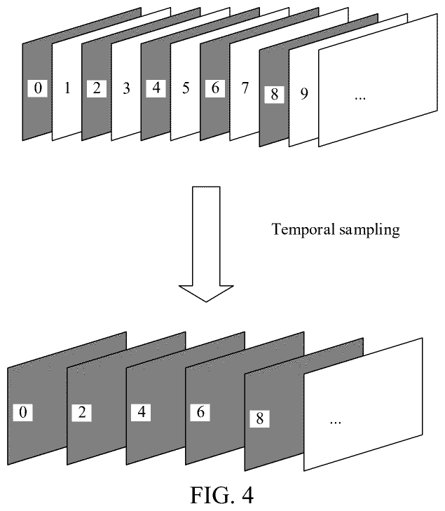

The encoding device may extract video frames from the original video data at intervals according to the play sequence number of the video frame in the original video data and the target sampling rate in the temporal sampling mode and use the extracted video frames as the sampled video data. As shown in FIG. 4, FIG. 4 is a schematic diagram of a temporal sampling mode according to some embodiments. As shown in FIG. 4, the total video frame quantity of video frames included in the original video data is 10 frames, the target sampling rate in the temporal sampling mode is 2, and the original video data includes a video frame 0, a video frame 1, a video frame 2, a video frame 3, a video frame 4, a video frame 5, a video frame 6, a video frame 7, a video frame 8, a video frame 9, and the like. The encoding device may extract one video frame every one video frame from the original video data, for example, extract the video frame 0, the video frame 2, the video frame 4, the video frame 6, the video frame 8, and the like as the sampled video data. The video frame 0, the video frame 1, the video frame 2, the video frame 3, the video frame 4, the video frame 5, the video frame 6, the video frame 7, the video frame 8, the video frame 9, and the like included in the original video data are sampled at a rate of 2 in the temporal sampling mode, to obtain the sampled video data, for example, the video frame 0, the video frame 2, the video frame 4, the video frame 6, the video frame 8, and the like.

In some embodiments, based on the encoding device sampling the original video data by using the temporal sampling mode and the target sampling rate in the temporal sampling mode, to obtain the sampled video data, such that the decoding device may restore the total video frame quantity of the original video data, the encoding device may transmit the total video frame quantity and the target sampling rate in the temporal sampling mode to the decoding device. The decoding device may be configured to perform sampling restoration on the sampled video data corresponding to the encoded video data according to the total video frame quantity and the target sampling rate in the temporal sampling mode, to restore a quantity of frames in the original video data.

In some embodiments, based on the encoding device sampling the original video data by using the temporal sampling mode, such that the decoding device may restore the total video frame quantity of the original video data, the encoding device may transmit a tail dropped frame quantity based on sampling and the target sampling rate in the temporal sampling mode to the decoding device. The decoding device may be configured to perform sampling restoration on the sampled video data corresponding to the encoded video data according to the tail dropped frame quantity and the target sampling rate in the temporal sampling mode, to restore a quantity of frames in the original video data. The quantity tail dropped frame may be a quantity of tail dropped video frames based on temporal sampling being performed on the original video data.

Based on the encoding device transmitting the tail dropped frame quantity based on sampling and the target sampling rate in the temporal sampling mode to the decoding device, TemporalScaleFlag (a temporal sampling flag), TemporalRatio (a target sampling rate flag in the temporal sampling mode), and DroppedFrameNumber (a tail dropped frame quantity flag) may be generated. A value of TemporalScaleFlag may be 0 or 1. Based on the value of TemporalScaleFlag being 1, the encoding device samples the original video data by using the temporal sampling mode. Based on the value of TemporalScaleFlag being 0, the encoding device samples the original video data without using the temporal sampling mode. Based on the value of TemporalScaleFlag being 1, TemporalRatio may be set to the target sampling rate in the temporal sampling mode, for example a value of TemporalRatio may be 2, 3, 4, or the like. Based on the value of TemporalScaleFlag being 1, DroppedFrameNumber may be set to a quantity of tail dropped video frames based on temporal sampling being performed on the original video data. For example, after the video frame 0, the video frame 1, the video frame 2, the video frame 3, the video frame 4, the video frame 5, the video frame 6, the video frame 7, the video frame 8, and the video frame 9 included in the original video data are sampled by using the temporal sampling mode and the target sampling rate of 2 in the temporal sampling mode, the quantity of tail dropped video frames is 1 (for example, the video frame 9 is tail dropped). The original video data is sampled based on the play sequence number of the video frame in the original video data and the first video frame quantity determined according to the total video frame quantity and the target sampling rate, so that omission and deviation may be avoided, thereby providing accuracy of sampling the video frames.

In some embodiments, a manner in which the encoding device samples the original video data according to the target sampling parameter, to obtain the sampled video data may include: if the target sampling mode is a spatial sampling mode, obtaining an original video resolution of a video frame Mᵢ in the original video data, where i is a positive integer less than or equal to M, and M is a quantity of video frames in the original video data; performing resolution conversion on the video frame Mᵢ having the original video resolution according to a target sampling rate in the spatial sampling mode and the original video resolution of the video frame Mᵢ, to obtain a video frame Mᵢ having a target video resolution; and based on performing resolution sampling on all video frames in the original video data, determining original video data obtained through resolution conversion as the sampled video data.

If the target sampling mode is a spatial sampling mode, the encoding device may obtain an original video resolution of a video frame Mᵢ in the original video data. The original video resolution may be configured for reflecting a quantity of pixels in the original video data. If the original video resolution of the video frame Mᵢ in the original video data is higher, more pixels are included in the video frame Mᵢ, and the video frame Mᵢ are clearer. If the original video resolution of the video frame Mᵢ in the original video data is lower, less pixels are included in the video frame Mᵢ, and the video frame Mᵢ are more blurred. For example, pixels included in a video frame whose video resolution is 1920*1080 are greater than pixels included in a video frame whose video resolution is 720*480, but a data amount obtained by encoding the video frame whose video resolution is 1920*1080 is greater than a data amount obtained by encoding the video frame whose video resolution is 720*480. M is a quantity of video frames in the original video data, and M is a positive integer. For example, M may be 1, 2, 3, . . . , and i may be a positive integer less than or equal to M.

Further, the encoding device may perform resolution conversion on the video frame Mᵢ having the original video resolution according to a target sampling rate in the spatial sampling mode and the original video resolution of the video frame Mᵢ, to obtain a video frame Mᵢ having a target video resolution. Based on performing resolution sampling on all video frames in the original video data, the encoding device determines original video data obtained through resolution conversion as the sampled video data. A video resolution of the original video data is sampled by using the spatial sampling mode and the target sampling rate in the spatial sampling mode, such that the perception requirement of the target object may be met, and the data amount of the encoded video data corresponding to the original video data can also be reduced, thereby improving transmission efficiency of the encoded video data. Therefore, the decoding device can rapidly obtain the encoded video data and decode the encoded video data, to improve decoding efficiency.

The encoding device may perform resolution conversion on the video frame Mᵢ having the original video resolution by using any spatial sampling method of a nearest neighbor interpolation method, a re-sampling filtering method, a bilinear interpolation method, and a sampling model prediction method (for example, a video super-resolution neural network or an image super-resolution neural network), to obtain a video frame Mᵢ having a target video resolution. The video frame Mᵢ having the original video resolution includes Q original pixels and pixel values respectively corresponding to the Q original pixels, where Q is a positive integer. A manner in which the encoding device may perform resolution conversion on the video frame Mᵢ having the original video resolution by using the nearest neighbor interpolation method, to obtain the video frame Mᵢ having the target video resolution may include: using a product of the target sampling rate in the spatial sampling mode and the original video resolution as an initial video resolution. The initial video resolution includes P sampling pixels, where P is a positive integer. Further, the encoding device may determine a reference pixel corresponding to a sampling pixel Pⱼ in the Q original pixels, where the sampling pixel Pⱼ belongs to the P sampling pixels, and j is a positive integer less than or equal to P. A pixel value of the reference pixel is used as a pixel value of the sampling pixel Pⱼ. Based on pixel values respectively corresponding to the P sampling pixels are obtained, a video frame Mᵢ having the initial video resolution is generated according to the P sampling pixels and the pixel values respectively corresponding to the P sampling pixels.

In some embodiments, a manner in which the encoding device obtains the video frame Mᵢ having the target video resolution may include: using a product of the target sampling rate in the spatial sampling mode and the original video resolution of the video frame Mᵢ as an initial video resolution; performing resolution conversion on the video frame Mᵢ having the original video resolution, to obtain a video frame Mᵢ having the initial video resolution; if the video frame Mᵢ having the initial video resolution does not meet an encoding condition, performing pixel padding on the video frame Mᵢ having the initial video resolution, determining a video resolution of a video frame Mᵢ obtained through padding as the target video resolution, and determining the video frame Mᵢ obtained through padding as the video frame Mᵢ having the target video resolution; and if the video frame Mᵢ having the initial video resolution meets the encoding condition, determining the initial video resolution as the target video resolution, and determining the video frame Mᵢ having the initial video resolution as the video frame Mᵢ having the target video resolution.

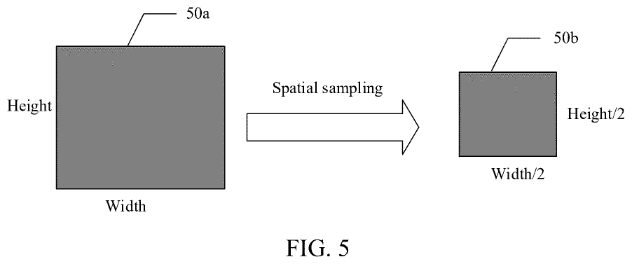

The encoding device may use a product of the target sampling rate in the spatial sampling mode and the original video resolution of the video frame Mᵢ as an initial video resolution. Further, resolution conversion is performed on the video frame Mᵢ having the original video resolution, to obtain a video frame Mᵢ having the initial video resolution. The encoding device may denote the original video resolution of the video frame Mᵢ as width*height (for example, width*height), and denote the target sampling rate in the spatial sampling mode as q, so that the initial video resolution is width*q*height*q. As shown in FIG. 5, FIG. 5 is a schematic diagram of a spatial sampling mode according to some embodiments. As shown in FIG. 5, the target sampling rate in the spatial sampling mode is denoted as 1/2. Based on an original video resolution of a video frame 50a being width*height, the encoding device may use a product of 1/2 sampling rate in the spatial sampling mode and the original video resolution of the video frame 50a as an initial video resolution width/2*height/2. Further, the encoding device may perform resolution conversion on the video frame 50a having the original video resolution by using any spatial sampling method of a nearest neighbor interpolation method, a re-sampling filtering method, a bilinear interpolation method, and a sampling model prediction method, to obtain a video frame 50b having the initial video resolution width/2*height/2. Because an encoder in the encoding device can encode a video frame in a fixed resolution format, the encoding device may detect whether the video frame Mᵢ having the initial video resolution meets an encoding condition. The encoding condition may be that a resolution is a multiple of 8, for example, in the video resolution, a width is a multiple of 8, and a height is a multiple of 8. For example, based on the initial video resolution of the video frame Mᵢ being 720*480, 720 is a multiple of 8, and 480 is a multiple of 8. Therefore, the encoding device may determine that the video frame Mᵢ having the initial video resolution meets the encoding condition. Based on the initial video resolution of the video frame Mᵢ being 727*483, 727 is not a multiple of 8, and 483 is not a multiple of 8. Therefore, the encoding device may determine that the video frame Mᵢ having the initial video resolution does not meet the encoding condition.

Further, if the encoding device determines that the video frame Mᵢ having the initial video resolution does not meet the encoding condition, the encoding device may perform pixel padding on the video frame Mᵢ having the initial video resolution, and pad the initial video resolution into a video resolution meeting the encoding condition, to obtain a video frame Mᵢ obtained through padding. The encoding device may determine a video resolution of the video frame Mᵢ obtained through padding as the target video resolution, and determine the video frame Mᵢ obtained through padding as the video frame Mᵢ having the target video resolution. Based on performing pixel padding on the video frame Mᵢ having the initial video resolution, the encoding device may obtain a video resolution that meets the encoding condition and that has a smallest difference from the initial video resolution and use the video resolution as the target video resolution. For example, based on the initial video resolution of the video frame Mᵢ being 717*479, it may be determined that a difference between the video resolution 720*480 and the initial video resolution 717*479 is smallest. Therefore, pixel padding may be performed on the video frame Mᵢ having the resolution 717*479, to obtain the video frame Mᵢ having the resolution 720*480.

The encoding device may perform pixel padding on the video frame Mᵢ by using a target pixel value. The target pixel value may be any pixel value, for example, the target pixel value may be 0, 255, or the like. The target pixel value is not limited. For example, the encoding device may pad a horizontal direction (for example, a width direction) of the initial video resolution with three pixels whose pixel values are 0, and pad a vertical direction (for example, a height direction) of the initial video resolution with one pixel whose pixel value is 0, to obtain the video frame Mᵢ whose video resolution is 720*480 and that is obtained through padding. If the video frame Mᵢ having the initial video resolution meets the encoding condition, the initial video resolution is determined as the target video resolution, and the video frame Mᵢ having the initial video resolution is determined as the video frame Mᵢ having the target video resolution.

In some embodiments, based on the encoding device sampling the original video data by using the spatial sampling mode, if the video frame Mᵢ having the target video resolution is obtained through pixel padding, pixel padding location information for pixel padding in the video frame Mᵢ having the target video resolution is obtained, and the target sampling rate in the spatial sampling mode and the pixel padding location information are transmitted to the decoding device. The decoding device may be configured to perform, according to the target sampling rate in the spatial sampling mode and the pixel padding location information, sampling restoration on the sampled video data obtained by decoding the encoded video data, to restore the original video data. If the video frame Mᵢ having the target video resolution is not obtained through pixel padding, the target sampling rate in the spatial sampling mode is transmitted to the decoding device. The decoding device may be configured to perform sampling restoration on the sampled video data corresponding to the encoded video data according to the target sampling rate in the spatial sampling mode, to restore the original video data.

The encoding device may generate SpatialScaleFlag (a spatial sampling flag), SpatialScaleRatio (a target sampling rate flag in the spatial sampling mode), PaddingFlag (a pixel padding flag), PaddingX (a pixel value padded in a horizontal direction, for example, a width), and PaddingY (a pixel value padded in a vertical direction, for example, a height). A value of SpatialScaleFlag may be 0 or 1. Based on the value of SpatialScaleFlag being 1, the encoding device samples the original video data by using the spatial sampling mode. Based on the value of SpatialScaleFlag being 0, the encoding device samples the original video data without using the spatial sampling mode. Based on the value of SpatialScaleFlag being 1, SpatialScaleRatio may be set to the target sampling rate in the spatial sampling mode, for example, a value of SpatialScaleRatio may be any value greater than 0 such as 0.5, 0.75, or 2. Based on the value of SpatialScaleFlag being 1, a value of PaddingFlag may be set to 0 or 1. Based on the value of PaddingFlag being 1, there is a pixel padding operation in a spatial sampling process of the original video data (for example, the video frame Mᵢ having the target video resolution is obtained through pixel padding). Based on the value of PaddingFlag being 0, there is no pixel padding operation in the spatial sampling process of the original video data (for example, the video frame Mᵢ having the target video resolution is not obtained through pixel padding). Further, based on the value of PaddingFlag being 1, the encoding device may set PaddingX (the pixel value padded in the horizontal direction) and PaddingY (the pixel value padded in the vertical direction).

In some embodiments, an initial video resolution is determined, and a video frame that has the initial video resolution and that does not meet the encoding condition is padded, to determine a target video resolution. For a video frame that has the initial video resolution and that meets the encoding condition, the target video resolution is directly determined, which helps reduce a data amount of the encoded video data corresponding to the original video data, to improve transmission efficiency of the encoded video data, so that the decoding device can rapidly obtain the encoded video data and decode the encoded video data, to improve decoding efficiency.

In some embodiments, a manner in which the encoding device samples the original video data may include: if the target sampling mode is a temporal sampling mode and a spatial sampling mode, determining a quantity of to-be-extracted video frames in the original video data as a second video frame quantity according to a target sampling rate in the temporal sampling mode and a total video frame quantity in the original video data; extracting the second video frame quantity of video frames from the original video data according to a play sequence number of a video frame in the original video data as initial sampled video data; obtaining an original video resolution of a video frame Nⱼ in the initial sampled video data, where j is a positive integer less than or equal to N, and N is a quantity of video frames in the initial sampled video data; performing resolution conversion on the video frame Nⱼ having the original video resolution according to a target sampling rate in the spatial sampling mode and the original video resolution of the video frame Nⱼ, to obtain a video frame Nⱼ having a target video resolution; and based on performing resolution sampling on all video frames in the initial sampled video data, determining initial sampled video data obtained through resolution sampling as the sampled video data. The target sampling mode may be the temporal sampling mode and the target sampling mode may be the spatial sampling mode according to some embodiments. The original video data is sampled by using the target sampling mode in which the temporal sampling mode is combined with the spatial sampling mode, so that accuracy of sampling the original video data can be improved, video watching quality can be controlled, and redundancy of the encoded video data may be reduced.

Based on the target sampling mode being the temporal sampling mode and the spatial sampling mode, the encoding device may transmit the total video frame quantity in the original video data and the target sampling rate in the temporal sampling mode to the decoding device. In addition, if the video frame Nⱼ having the target video resolution is obtained through pixel padding, the encoding device may transmit the target sampling rate in the spatial sampling mode and pixel padding location information in the video frame Nⱼ having the target video resolution to the decoding device. If the video frame Nⱼ having the target video resolution is not obtained through pixel padding, the encoding device may transmit the target sampling rate in the spatial sampling mode to the decoding device, so that the decoding device restores a quantity of video frames and a video resolution of the original video data.
104: Encode the sampled video data, to obtain encoded video data corresponding to the original video data.

The encoding device may predict the sampled video data in a prediction mode such as intra-frame prediction or inter-frame prediction, to obtain a residual video signal of the sampled video data. Further, the encoding device may transform the residual video signal of the sampled video data, to obtain a transform domain signal of the sampled video data, and quantize the transform domain signal of the sampled video data, to obtain a quantized transform domain signal. Further, the encoding device may perform entropy coding on the quantized transform domain signal and output binarized (0 or 1) encoded video data. The encoding device may perform entropy coding on parameters such as the target sampling parameter, the total video frame quantity of the original video data, and the pixel padding location information, to reduce a bit rate. In some embodiments, the sampled video data may be encoded, so that the bit rate of the encoded video data can be reduced and the transmission efficiency of the encoded video data can be improved, thereby reducing storage space of the encoded video data.

In some embodiments, the encoding device may determine video region information (for example, a region of interest ROI) of the original video data, and transmit the video region information and the encoded video data to the decoding device. The video region information may be configured for indicating the decoding device to perform image enhancement processing on a video region in the original video data. The decoding device performs image enhancement processing on the video region in the original video data, to enrich a display effect of the original video data restored by the decoding device, to improve accuracy of restoring the original video data. In addition, based on an object recognition task being performed on the restored original video data, recognition accuracy can be improved.

In some embodiments, a manner in which the encoding device determines the video region information of the original video data may include: inputting the original video data into a target detection model, and performing embedding vector conversion on the original video data by using an embedding layer in the target detection model, to obtain a media embedding vector of the original video data; performing object extraction on the media embedding vector by using an object extraction layer in the target detection model, to obtain a video object in the original video data; and determining a region to which the video object belongs in the original video data as a video region, and generating the video region information for describing a location of the video region in the original video data. The encoding device may extract a video region in the original video data in another video region determining mode (for example, target detection or target recognition). This is not limited. The encoding device may generate ROINumber (a region quantity flag) and ROIInformation (a region feature information flag, for example, region coordinate information) based on extracting the video region in the original video data. ROINumber may be configured for indicating a quantity of video regions in current original video data or a current video frame. Based on ROINumber being greater than 0, ROIInformation whose quantity is ROINumber is transferred. ROIInformation may be configured for indicating information about the video region (for example, the region of interest), for example, coordinates and a type of a video object included in the video region. As shown in Table 1, based on performing temporal sampling and spatial sampling on the original video data, the encoding device may transmit parameters in Table 1, so that the decoding device restores the original video data according to the parameters in Table 1.

TABLE 1

| | Data | |
|---|---|---|
| Parameter | type | Description |
| SpatialScaleFlag | bool | SpatialScaleFlag indicates whether |
| | | spatial re-sampling is performed on |
| | | the video. Based on a value of the |
| | | field being 1, spatial sampling is |
| | | performed on the video, and based on |
| | | the value being 0, spatial sampling is |
| | | not performed on the video. |
| SpatialScaleRatio | float | SpatialScaleRatio indicates a spatial |
| | | sampling rate. |
| PaddingFlag | bool | PaddingFlag indicates whether a |
| | | pixel padding operation is performed |
| | | on the video based on spatial |
| | | re-sampling being performed. |
| PaddingX | int | PaddingX indicates a quantity of |
| | | pixels that are padded in a horizontal |
| | | direction. |
| Padding Y | int | PaddingY indicates a quantity of |
| | | pixels that are padded in a vertical |
| | | direction. |
| TemporalScaleFlag | bool | TemporalScaleFlag indicates whether |
| | | time domain re-sampling is |
| | | performed on the video. Based on a |
| | | value of the field being 1, time |
| | | domain sampling is performed on the |
| | | video, and based on the value being |
| | | 0, time domain sampling is not |
| | | performed on the video. |
| TemporalScaleRatio | int | TemporalScaleRatio indicates a time |
| | | domain sampling rate. |
| DroppedFrameNumber | int | DroppedFrameNumber indicates a |
| | | tail dropped frame quantity of the |
| | | video. |
| ROINumber | int | ROINumber indicates a quantity of |
| | | video regions in the video. |
| ROIinformation | | ROIinformation indicates related |
| | | information of the video region, for |
| | | example, coordinates. |

In some embodiments, a target sampling parameter of original video data is adaptively determined according to a media application scenario and a video content feature of the original video data, and the original video data is sampled based on the target sampling parameter, to obtain sampled video data, so that accuracy of sampling the original video data can be improved, video viewing quality can be controlled, and redundancy of encoded video data is reduced. Further, the sampled video data is encoded, to obtain encoded video data. The encoded video data may be transmitted to a decoding device, so that a data amount of the encoded video data can be reduced and transmission efficiency of the encoded video data is improved. Therefore, the decoding device can rapidly obtain the encoded video data, and encoding efficiency of the original video data can also be improved.

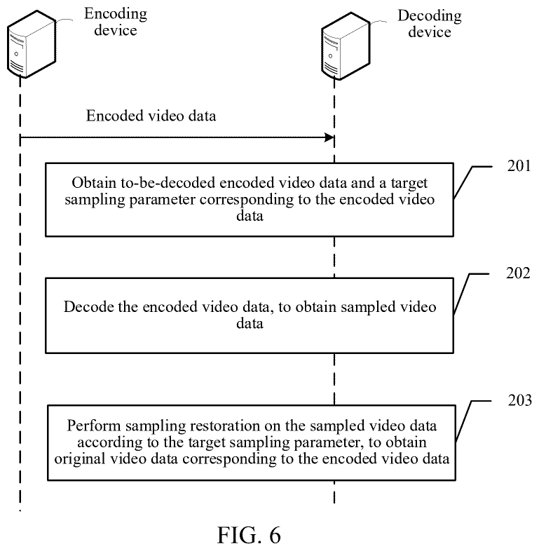

As shown in FIG. 6, FIG. 6 shows a video decoding method according to some embodiments. The video decoding method provided in some embodiments is described below with reference to FIG. 6. The method may be performed by a computer device. The computer device may be a decoding device. As shown in FIG. 6, the method may include, but not limited to, the following operations.
201: Obtain to-be-decoded encoded video data and a target sampling parameter corresponding to the encoded video data.

The decoding device may obtain to-be-decoded encoded video data and a target sampling parameter corresponding to the encoded video data. The encoded video data is obtained by encoding sampled video data, the sampled video data is obtained by sampling original video data corresponding to the encoded video data based on the target sampling parameter, and the target sampling parameter is determined according to a media application scenario and a video content feature of the original video data.

In some embodiments, the target sampling parameter is transmitted by an encoding device. The target sampling parameter includes a target sampling mode and a target sampling rate in the target sampling mode. The target sampling mode is determined according to the video content feature of the original video data. The target sampling rate in the target sampling mode is determined according to a video perceptual feature and the video content feature, the video perceptual feature is a perceptual feature of a target object for video data in the media application scenario, and the target object is an object that perceives the original video data. The target sampling mode may include a temporal sampling mode and a target sampling rate in the temporal sampling mode and a spatial sampling mode and a target sampling rate in the spatial sampling mode. For determining the target sampling parameter, refer to the content in operation 102 in FIG. 3. The to-be-decoded encoded video data is obtained through encoding based on the adaptively determined target sampling mode and the target sampling rate in the target sampling mode. The target sampling mode and the target sampling rate in the target sampling mode are determined according to the media application scenario and the video content feature, so that a data amount of the encoded video data obtained by encoding the original video data can be reduced, thereby reducing a data amount that is processed during video decoding and improving efficiency of decoding video data.
202: Decode the encoded video data, to obtain the sampled video data.

A decoding process of the decoding device is opposite to an encoding process of the encoding device. The decoding device may obtain the to-be-decoded encoded video data transmitted by the encoding device, perform entropy decoding on the encoded video data, and obtain various parameters and a quantized transform coefficient. Dequantization and inverse transform are performed on the quantized transform coefficient, to obtain a residual video signal. In addition, a corresponding video predicted signal may be obtained according to known encoding mode information transmitted by the encoding device, and a reconstructed video signal may be obtained by adding the video predicted signal and the residual video signal. Finally, a loop filtering operation may be performed on the reconstructed video signal, to generate sampled video data. The sampled video data may be the sampled video data obtained by sampling the original video data by the encoding device.
203: Perform sampling restoration on the sampled video data according to the target sampling parameter, to obtain the original video data corresponding to the encoded video data.

The decoding device may perform sampling restoration on the sampled video data according to the target sampling parameter, to obtain the original video data corresponding to the encoded video data. The decoding device rapidly obtains the encoded video data in a low bit rate, and decodes and performs sampling restoration on the encoded video data in the low bit rate, to obtain the original video data corresponding to the encoded video data, so that decoding efficiency of decoding the encoded video data can be improved, and storage space of the encoded video data can be reduced.

In some embodiments, a manner in which the decoding device performs sampling restoration on the sampled video data may include: if the target sampling mode is a temporal sampling mode, determining a third video frame quantity between a first decoded video frame and a second decoded video frame according to a target sampling rate in the temporal sampling mode, where the first decoded video frame and the second decoded video frame are video frames whose play sequence numbers have a neighboring relationship in the sampled video data; and the third video frame quantity is a quantity of to-be-restored video frames between the first decoded video frame and the second decoded video frame; inserting the third video frame quantity of restored video frames between the first decoded video frame and the second decoded video frame; and determining, based on a restored video frame being inserted between any two adjacent decoded video frames in the sampled video data, the original video data corresponding to the encoded video data according to sampled video data obtained through restoration.

If a parameter that is transmitted by the encoding device and that is received by the decoding device indicates the encoding device to sample the original video data by using a temporal sampling mode, the decoding device may determine that the target sampling mode is the temporal sampling mode, obtain a target sampling rate in the temporal sampling mode, and determine a third video frame quantity of to-be-restored video frames between a first decoded video frame a the second decoded video frame according to the target sampling rate in the temporal sampling mode. If the target sampling rate in the temporal sampling mode is n (for example, collecting one video frame every n−1 video frames), the third video frame quantity of to-be-restored video frames between the first decoded video frame and the second decoded video frame is n−1. For example, if the target sampling rate in the temporal sampling mode is 2 (for example, collecting one video frame every one video frame), the third video frame quantity of to-be-restored video frames between the first decoded video frame and the second decoded video frame is 1. If the target sampling rate in the temporal sampling mode is 3 (for example, collecting one video frame every two video frames), the third video frame quantity of to-be-restored video frames between the first decoded video frame and the second decoded video frame is 2. Further, the decoding device may insert the third video frame quantity of restored video frames between the first decoded video frame and the second decoded video frame; and determine, based on a restored video frame being inserted between any two adjacent decoded video frames in the sampled video data, the original video data corresponding to the encoded video data according to sampled video data obtained through restoration.

In some embodiments, the third video frame quantity of restored video frames is generated according to the first decoded video frame; or the third video frame quantity of restored video frames is generated according to the second decoded video frame; or the third video frame quantity of restored video frames is generated according to the first decoded video frame and the second decoded video frame.

The third video frame quantity of restored video frames may be the same as the first decoded video frame, for example, the third video frame quantity of first decoded video frames is inserted between the first decoded video frame and the second decoded video frame. The third video frame quantity of restored video frames may be the same as the second decoded video frame, for example, the third video frame quantity of second decoded video frames is inserted between the first decoded video frame and the second decoded video frame. The third video frame quantity of repeated video frames (the repeated video frame may be the first decoded video frame or the second decoded video frame) is inserted between the first decoded video frame and the second decoded video frame. The third video frame quantity of restored video frames may be obtained through network prediction according to the first decoded video frame and the second decoded video frame. For example, the decoding device may predict object motion information of a restored video frame between the first decoded video frame and the second decoded video frame according to object motion information of the first decoded video frame and object motion information of the second decoded video frame. A plurality of restored video frames are inserted between video frames whose play sequence numbers have a neighboring relationship, to accurately and rapidly decode the encoded video data.

In some embodiments, a manner in which the decoding device determines the original video data corresponding to the encoded video data according to the sampled video data obtained through restoration may include: based on the restored video frame being inserted between the any two adjacent decoded video frames in the sampled video data, obtaining a fourth video frame quantity of video frames included in the sampled video data obtained through restoration and a total video frame quantity of video frames included in the original video data; if the fourth video frame quantity is the same as the total video frame quantity, determining the sampled video data obtained through restoration as the original video data corresponding to the encoded video data; and if the fourth video frame quantity is different from the total video frame quantity, obtaining a difference between the fourth video frame quantity and the total video frame quantity as a fifth video frame quantity, and inserting the fifth video frame quantity of restored video frames after the sampled video data obtained through restoration, to obtain the original video data corresponding to the encoded video data.

If a parameter that is transmitted by the encoding device and that is obtained by the decoding device includes a total video frame quantity of video frames included in the original video data, based on a restored video frame being inserted between any two adjacent decoded video frames in the sampled video data, the decoding device may obtain a quantity of video frames included in the sampled video data obtained through restoration as a fourth video frame quantity. Further, the decoding device may detect whether the fourth video frame quantity of video frames included in the sampled video data obtained through restoration is the same as the total video frame quantity of video frames included in the original video data. If the fourth video frame quantity is different from the total video frame quantity, the decoding device obtains a difference between the fourth video frame quantity and the total video frame quantity as a fifth video frame quantity, and inserts the fifth video frame quantity of restored video frames after the sampled video data obtained through restoration, to obtain the original video data corresponding to the encoded video data. A quantity of video frames in the original video data can be accurately restored. The fifth video frame quantity of restored video frames may be determined according to a video frame whose a play sequence is the latest in the sampled video data obtained through restoration, for example, the fifth video frame quantity of restored video frames may be a video frame whose play sequence is the latest in the sampled video data obtained through restoration, or may be obtained through network prediction according to the video frame whose play sequence is the latest in the sampled video data obtained through restoration. If the fourth video frame quantity is the same as the total video frame quantity, the sampled video data obtained through restoration may be determined as the original video data corresponding to the encoded video data.

If a parameter that is transmitted by the encoding device and that is obtained by the decoding device includes a tail dropped video frame quantity of video frames included in the original video data, the tail dropped video frame quantity of restored video frames may be directly inserted after the sampled video data obtained through restoration, to obtain the original video data corresponding to the encoded video data. The quantity of video frames in the original video data can be accurately restored by using the total video frame quantity of video frames included in the original video data, to control decoding quality of video data. The tail dropped video frame quantity of restored video frames may be determined according to the video frame whose play sequence is the latest in the sampled video data obtained through restoration.

In some embodiments, a manner in which the decoding device performs sampling restoration on the sampled video data may include: if the target sampling mode is a spatial sampling mode, obtaining a current target video resolution of a third decoded video frame in the sampled video data; performing resolution restoration on the third decoded video frame having the target video resolution according to a target sampling rate in the spatial sampling mode and the target video resolution, to obtain a third decoded video frame having an original video resolution; and based on all decoded video frames in the sampled video data being restored, determining sampled video data obtained through restoration as the original video data corresponding to the encoded video data.

If the target sampling mode is a spatial sampling mode, a third decoded video frame in the sampled video data is used as an example, the third decoded video frame is any video frame in the sampled video data, and the decoding device may obtain a current target video resolution of the third decoded video frame in the sampled video data and obtain a target sampling rate in the spatial sampling mode. Further, the decoding device may obtain an initial video resolution by using a ratio of the current target video resolution of the third decoded video frame to the target sampling rate in the spatial sampling mode (for example, the target video resolution/the target sampling rate in the spatial sampling mode). The decoding device may perform restoration processing on the third decoded video frame having the target video resolution by using a spatial sampling restoration method, to obtain a third decoded video frame having the initial video resolution. Further, a third decoded video frame having an original video resolution is generated according to the third decoded video frame having the initial video resolution. The spatial sampling restoration method may be any one of a nearest neighbor interpolation method, a re-sampling filtering method, a bilinear interpolation method, and a sampling model prediction method, and may be the same as the spatial sampling method in the encoding device, or may be different from the spatial sampling mode in the encoding device. Based on all the decoded video frames in the sampled video data being restored, the sampled video data obtained through restoration is determined as the original video data corresponding to the encoded video data. Resolution restoration is performed, by using the target video resolution, on the encoded video data obtained through encoding in the spatial sampling mode, so that the original video resolution of the original video data can be accurately restored, to improve decoding accuracy.

In some embodiments, a manner in which the decoding device obtains the third decoded video frame having the original video resolution may include: if pixel padding location information of the third decoded video frame is received, performing pixel cropping on the third decoded video frame having the target video resolution according to the pixel padding location information, to obtain a third decoded video frame having an initial video resolution, determining a ratio of the initial video resolution to the target sampling rate in the spatial sampling mode as a to-be-restored original video resolution of the third decoded video frame, and performing resolution restoration on the third decoded video frame having the initial video resolution, to obtain the third decoded video frame having the original video resolution; and if the pixel padding location information of the third decoded video frame is not received, determining a ratio of the target sampling rate in the spatial sampling mode to the target video resolution as a to-be-restored original video resolution of the third decoded video frame, and performing resolution restoration on the third decoded video frame having the target video resolution, to obtain the third decoded video frame having the original video resolution.

For example, the target sampling rate in the spatial sampling mode is 0.5, and the target video resolution of the third decoded video frame is 960*544. If received pixel padding location information corresponding to the third decoded video frame is that four pixel values are padded in a vertical direction, the decoding device may perform pixel cropping on pixel values of the third decoded video frame whose target video resolution is 960*544 in the vertical direction by four pixel values, to obtain a third decoded video frame having an initial video resolution 960*540. Further, the decoding device may obtain a ratio of the initial video resolution 960*540 to 0.5 (for example, the target sampling rate in the spatial sampling mode) (for example, (960*540)/0.5), to obtain a to-be-restored original video resolution of the third decoded video frame, for example, 1920*1080. Further, the decoding device may perform resolution restoration on the third decoded video frame having the target video resolution according to any one of a nearest neighbor interpolation method, a re-sampling filtering method, a bilinear interpolation method, and a sampling model prediction method, to obtain the third decoded video frame having the original video resolution. Resolution restoration is performed on the original video resolution based on the pixel padding location information, or the original video resolution is directly determined, so that the original video resolution of the original video data can be accurately restored, to improve decoding accuracy.

In some embodiments, a manner in which the decoding device performs sampling restoration on the sampled video data may include: if the target sampling mode is a temporal sampling mode and a spatial sampling mode, obtaining a target video resolution of a third decoded video frame in the sampled video data, and performing resolution restoration on the target video resolution of the third decoded video frame according to a target sampling rate in the spatial sampling mode and the target video resolution, to obtain a third decoded video frame having an original video resolution; based on all decoded video frames in the sampled video data being restored, determining sampled video data obtained through restoration as initial video data corresponding to the encoded video data; determining a sixth video frame quantity of to-be-restored video frames between a first initial video frame and a second initial video frame according to a target sampling rate in the temporal sampling mode, where the first initial video frame and the second initial video frame are video frames whose play sequence numbers have a neighboring relationship in the initial video data; and inserting the sixth video frame quantity of restored video frames between the first initial video frame and the second initial video frame, and determining, based on a restored video frame being inserted between any two adjacent initial video frames in the initial video data, the original video data corresponding to the encoded video data according to initial video data obtained through restoration.

If the decoding device receives parameters such as TemporalScaleFlag (a temporal sampling flag), TemporalRatio (a target sampling rate flag in a temporal sampling mode), DroppedFrameNumber (a tail dropped frame quantity flag), SpatialScaleFlag (a spatial sampling flag), SpatialScaleRatio (a target sampling rate flag in a spatial sampling mode), PaddingFlag (a pixel padding flag), PaddingX (a pixel value padded in a horizontal direction, for example, a width direction), and PaddingY (a pixel value padded in a vertical direction, for example, a height direction) that are transmitted by the encoding device, the decoding device may determine, according to SpatialScaleFlag in the parameters, whether spatial sampling is performed on the sampled video data obtained through decoding. If a value of SpatialScaleFlag is 1, SpatialScaleRatio and PaddingFlag continue to be obtained from the parameters. If a value of PaddingFlag is 1, PaddingX and PaddingY continue to be obtained, and pixels padded in the sampled video data in the horizontal direction and the vertical direction are cropped. An original video resolution is calculated according to SpatialScaleRatio and a target video resolution of cropped sampled video data, and restoration processing is performed on the cropped sampled video data by using the spatial sampling method (for example, nearest neighbor interpolation, bilinear interpolation, or a video or image super-resolution neural network), to obtain initial video data corresponding to the sampled video data.

Further, the decoding device may determine, according to TemporalScaleFlag in the parameters, whether temporal sampling is performed on the sampled video data. If a value of TemporalScaleFlag is 1, TemporalRatio and DroppedFrameNumber continue to be obtained from the parameters. The decoding device determines a sixth video frame quantity of restored video frames between a first initial video frame and a second initial video frame in the initial video data according to TemporalRatio. The first initial video frame and the second initial video frame are video frames whose play sequence numbers have a neighboring relationship in the initial video data. For example, a to-be-restored video frame between the first initial video frame and the second initial video frame is determined through a repeated frame, a video interpolation network, or the like. Determining the to-be-restored video frame between the first decoded video frame and the second decoded video frame may be applied according to some embodiments. The sixth video frame quantity of restored video frames is inserted between the first initial video frame and the second initial video frame, and based on a restored video frame being inserted between any two adjacent initial video frames in the initial video data, a missing video frame in the initial video data obtained through restoration is padded according to DroppedFrameNumber, to obtain corresponding original video data based on cropping.

In some embodiments, the decoding device may receive video region information of the encoded video data transmitted by the encoding device, and determine a video region in the original video data according to the video region information. Image enhancement is performed on the video region in the original video data, to obtain original video data obtained through image enhancement. If the decoding device obtains ROINumber (a region quantity flag) and ROIInformation (a region feature information flag, for example, region coordinate information), the decoding device may perform image enhancement processing on all video regions in the original video data according to ROINumber (the region quantity flag) and ROIInformation (the region feature information flag, for example, the region coordinate information). A display effect of the original video data obtained through restoration can be improved, and restoration accuracy of the original video data can also be improved. In addition, based on an object recognition task being performed on the restored original video data, recognition accuracy can be improved.

In some embodiments, a manner in which the decoding device performs image enhancement on the video region in the original video data, to obtain the original video data obtained through image enhancement may include: inputting the video region in the original video data into an image enhancement model, and generating an image enhancement coefficient of the video region in the original video data by using an enhancement coefficient generation layer in the image enhancement model; and performing image enhancement on the video region in the original video data by using an image enhancement layer in the image enhancement model, to obtain the original video data obtained through image enhancement. Image enhancement processing is performed on the video region in the original video data by using the image enhancement model, so that image enhancement efficiency and accuracy can be improved. The decoding device may perform image enhancement processing on the video region in the original video data in another image enhancement mode. This is not limited.

In some embodiments, to-be-decoded encoded video data is decoded, to obtain sampled video data. A target sampling parameter is determined according to a media application scenario and a video content feature of original video data corresponding to the encoded video data. Therefore, the encoded video data is obtained by sampling and encoding the original video data according to a target sampling parameter. The target sampling parameter is determined according to the media application scenario and the video content feature of the original video data corresponding to the encoded video data. Because the encoded video data is obtained by encoding the sampled video data, for example, the encoded video data is obtained by encoding a part of video content in the original video data, for example, in a decoding process, encoded data in a part of video content may be decoded, thereby improving decoding efficiency of video data. In addition, sampling restoration is performed on the sampled video data based on the target sampling parameter, so that the original video data may be restored, thereby improving quality of video data.

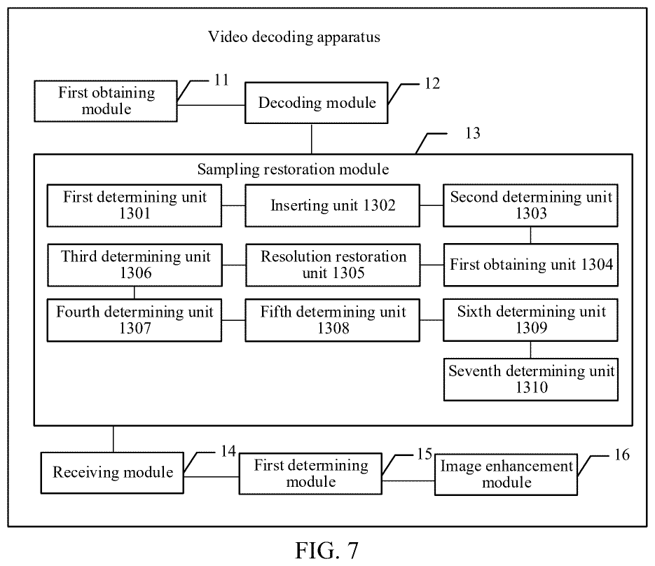

Referring to FIG. 7, FIG. 7 is a schematic structural diagram of a video decoding apparatus according to some embodiments. The video decoding apparatus may be computer-readable instructions (including program code) run on a computer device. For example, the video decoding apparatus is application software. The video decoding apparatus may be configured to perform corresponding operations in the video decoding method provided in some embodiments. As shown in FIG. 7, the video decoding apparatus may include: a first obtaining module 11, a decoding module 12, a sampling restoration module 13, a receiving module 14, a first determining module 15, and an image enhancement module 16.

The first obtaining module 11 may be configured to obtain to-be-decoded encoded video data and a target sampling parameter corresponding to the encoded video data. The encoded video data is obtained by encoding sampled video data, the sampled video data is obtained by sampling original video data corresponding to the encoded video data based on the target sampling parameter, and the target sampling parameter is determined according to a media application scenario and a video content feature of the original video data. The decoding module 12 may be configured to decode the encoded video data, to obtain the sampled video data. The sampling restoration module 13 may be configured to perform sampling restoration on the sampled video data according to the target sampling parameter, to obtain the original video data corresponding to the encoded video data.

The target sampling parameter is transmitted by an encoding device, and the target sampling parameter includes a target sampling mode and a target sampling rate in the target sampling mode. The target sampling mode is determined according to the video content feature of the original video data. The target sampling rate in the target sampling mode is determined according to a video perceptual feature and the video content feature. The video perceptual feature is a perceptual feature of a target object for video data in the media application scenario, and the target object is an object that perceives the original video data.

The sampling restoration module 13 includes: a first determining unit 1301, configured to: if the target sampling mode is a temporal sampling mode, determine a third video frame quantity between a first decoded video frame and a second decoded video frame according to a target sampling rate in the temporal sampling mode, where the first decoded video frame and the second decoded video frame are video frames whose play sequence numbers have a neighboring relationship in the sampled video data; and the third video frame quantity is a quantity of to-be-restored video frames between the first decoded video frame and the second decoded video frame; an inserting unit 1302, configured to insert the third video frame quantity of restored video frames between the first decoded video frame and the second decoded video frame; and a second determining unit 1303, configured to determine, based on a restored video frame being inserted between any two adjacent decoded video frames in the sampled video data, the original video data corresponding to the encoded video data according to sampled video data obtained through restoration.

The third video frame quantity of restored video frames is generated according to the first decoded video frame; or the third video frame quantity of restored video frames is generated according to the second decoded video frame; or the third video frame quantity of restored video frames is generated according to the first decoded video frame and the second decoded video frame.

The second determining unit 1303 is configured to: based on the restored video frame b inserted between the any two adjacent decoded video frames in the sampled video data, obtain a fourth video frame quantity of video frames included in the sampled video data obtained through restoration and a total video frame quantity of video frames included in the original video data; if the fourth video frame quantity is the same as the total video frame quantity, determine the sampled video data obtained through restoration as the original video data corresponding to the encoded video data; and if the fourth video frame quantity is different from the total video frame quantity, obtain a difference between the fourth video frame quantity and the total video frame quantity as a fifth video frame quantity, and insert the fifth video frame quantity of restored video frames after the sampled video data obtained through restoration, to obtain the original video data corresponding to the encoded video data.

The sampling restoration module 13 further includes: a first obtaining unit 1304, configured to: if the target sampling mode is a spatial sampling mode, obtain a current target video resolution of a third decoded video frame in the sampled video data; a resolution restoration unit 1305, configured to perform resolution restoration on the third decoded video frame having the target video resolution according to a target sampling rate in the spatial sampling mode and the target video resolution, to obtain a third decoded video frame having an original video resolution; and a third determining unit 1306, configured to: based on all decoded video frames in the sampled video data being restored, determine sampled video data obtained through restoration as the original video data corresponding to the encoded video data.

The resolution restoration unit 1305 is configured to perform at least one of the following: if pixel padding location information of the third decoded video frame is received, performing pixel cropping on the third decoded video frame having the target video resolution according to the pixel padding location information, to obtain a third decoded video frame having an initial video resolution, determining a ratio of the initial video resolution to the target sampling rate in the spatial sampling mode as a to-be-restored original video resolution of the third decoded video frame, and performing resolution restoration on the third decoded video frame having the initial video resolution, to obtain the third decoded video frame having the original video resolution; and if the pixel padding location information of the third decoded video frame is not received, determining a ratio of the target sampling rate in the spatial sampling mode to the target video resolution as a to-be-restored original video resolution of the third decoded video frame, and performing resolution restoration on the third decoded video frame having the target video resolution, to obtain the third decoded video frame having the original video resolution.

The sampling restoration module 13 further includes: a fourth determining unit 1307, configured to: if the target sampling mode is a temporal sampling mode and a spatial sampling mode, obtain a target video resolution of a third decoded video frame in the sampled video data, and perform resolution restoration on the target video resolution of the third decoded video frame according to a target sampling rate in the spatial sampling mode and the target video resolution, to obtain a third decoded video frame having an original video resolution; a fifth determining unit 1308, configured to: based on all decoded video frames in the sampled video data being restored, determine sampled video data obtained through restoration as initial video data corresponding to the encoded video data; a sixth determining unit 1309, configured to determine a sixth video frame quantity of to-be-restored video frames between a first initial video frame and a second initial video frame according to a target sampling rate in the temporal sampling mode, where the first initial video frame and the second initial video frame are video frames whose play sequence numbers have a neighboring relationship in the initial video data; and a seventh determining unit 1310, configured to insert the sixth video frame quantity of restored video frames between the first initial video frame and the second initial video frame, and determine, based on a restored video frame being inserted between any two adjacent initial video frames in the initial video data, the original video data corresponding to the encoded video data according to initial video data obtained through restoration.

The video decoding apparatus further includes: the receiving module 14, configured to receive video region information of the encoded video data transmitted by the encoding device; the first determining module 15, configured to determine a video region in the original video data according to the video region information; and the image enhancement module 16, configured to perform image enhancement on the video region in the original video data, to obtain original video data obtained through image enhancement.

The image enhancement module 16 includes: a first generation unit 1601, configured to input the video region in the original video data into an image enhancement model, and generate an image enhancement coefficient of the video region in the original video data by using an enhancement coefficient generation layer in the image enhancement model; and an image enhancement unit 1602, configured to perform image enhancement on the video region in the original video data by using an image enhancement layer in the image enhancement model, to obtain the original video data obtained through image enhancement.

According to some embodiments, modules in the video decoding apparatus shown in FIG. 7 may be separately or wholly combined into one or several units, or one (or more) of the units herein may further be divided into a plurality of subunits of smaller functions. Same operations can be implemented, and implementation of the technical effects are not affected. The foregoing modules are divided based on logical functions. In an actual application, a function of one module may also be implemented by a plurality of units, or functions of a plurality of modules are implemented by one unit. In some embodiments, the video decoding apparatus may also include other units. During actual application, the functions may also be cooperatively implemented by other units and may be cooperatively implemented by a plurality of units.

On a decoding device side, encoded video data is decoded, to obtain sampled video data. Because the encoded video data is obtained by encoding the sampled video data, for example, the encoded video data is obtained by encoding a part of video content in the original video data, for example, in a decoding process, encoded data in a part of video content may be decoded, thereby improving decoding efficiency of video data. In addition, sampling restoration is performed on the sampled video data based on the target sampling parameter, so that the original video data may be restored, thereby improving quality of video data.

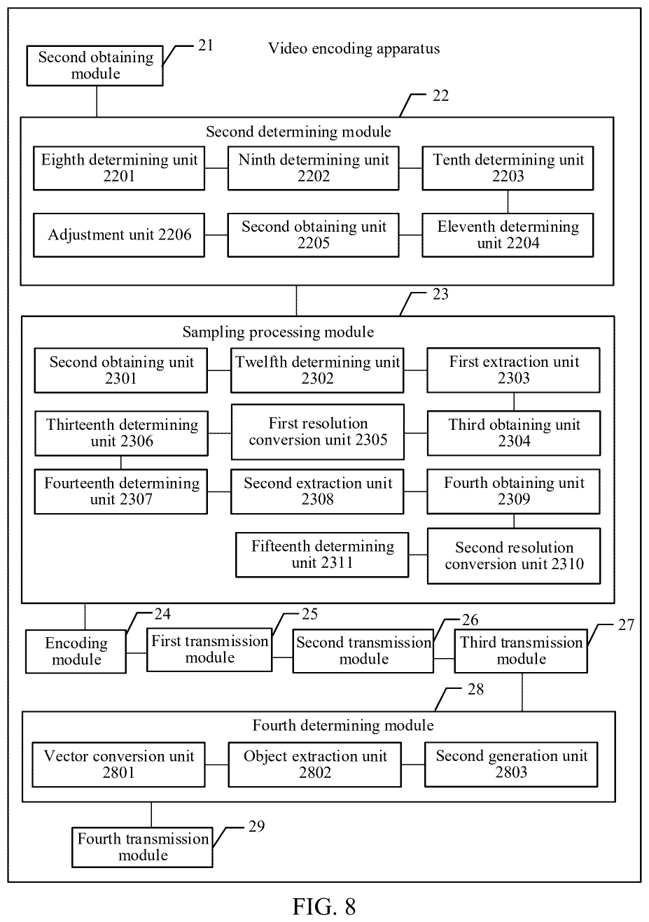

Referring to FIG. 8, FIG. 8 is a schematic structural diagram of a video encoding apparatus according to some embodiments. The video encoding apparatus may be computer-readable instructions (including program code) run on a computer device. For example, the video decoding apparatus is application software. The video encoding apparatus may be configured to perform corresponding operations in the video encoding method provided in some embodiments. As shown in FIG. 8, the video encoding apparatus may include: a second obtaining module 21, a second determining module 22, a sampling processing module 23, an encoding module 24, a first transmission module 25, a second transmission module 26, a third transmission module 27, a fourth determining module 28, and a fourth transmission module 29.

The second obtaining module 21 may be configured to obtain a media application scenario and a video content feature of to-be-encoded original video data.

The second determining module 22 may be configured to determine, according to the media application scenario and the video content feature, a target sampling parameter for sampling the original video data.

The sampling processing module 23 may be configured to sample the original video data according to the target sampling parameter, to obtain sampled video data.

The encoding module 24 may be configured to encode the sampled video data, to obtain encoded video data corresponding to the original video data.

The second determining module 22 includes: an eighth determining unit 2201, configured to determine, according to the video content feature, a target sampling mode for sampling the original video data; a ninth determining unit 2202, configured to determine a video perceptual feature of a target object for video data in the media application scenario, where the target object is an object that perceives the original video data; a tenth determining unit 2203, configured to determine a target sampling rate in the target sampling mode according to the video perceptual feature and the video content feature; and an eleventh determining unit 2204, configured to determine the target sampling rate and the target sampling mode as the target sampling parameter for sampling the original video data.

The eighth determining unit 2201 is configured to determine a repetition rate of video content in the original video data according to a video content change rate included in the video content feature; and determine, according to the repetition rate of the video content in the original video data, the target sampling mode for sampling the original video data.

The determining, according to the repetition rate of the video content in the original video data, the target sampling mode for sampling the original video data includes at least one of the following: if the repetition rate of the video content in the original video data is greater than a first repetition rate threshold, determining a temporal sampling mode and a spatial sampling mode as the target sampling mode for sampling the original video data; if the repetition rate of the video content in the original video data is less than or equal to the first repetition rate threshold and greater than a second repetition rate threshold, determining the temporal sampling mode as the target sampling mode for sampling the original video data, where the second repetition rate threshold is less than the first repetition rate threshold; and if the repetition rate of the video content in the original video data is less than or equal to the second repetition rate threshold, determining the spatial sampling mode as the target sampling mode for sampling the original video data.

The eighth determining unit 2201 is configured to determine complexity of video content in the original video data according to a video content information amount included in the video content feature; and determine, according to the complexity of the video content in the original video data, the target sampling mode for sampling the original video data.

The determining, according to the complexity of the video content in the original video data, the target sampling mode for sampling the original video data includes at least one of the following: if the complexity of the video content in the original video data is less than a first complexity threshold, determining a temporal sampling mode and a spatial sampling mode as the target sampling mode for sampling the original video data; if the complexity of the video content in the original video data is greater than or equal to the first complexity threshold and less than a second complexity threshold, determining the spatial sampling mode as the target sampling mode for sampling the original video data, where the second complexity threshold is greater than the first complexity threshold; and if the complexity of the video content in the original video data is greater than the second complexity threshold, determining the temporal sampling mode as the target sampling mode for sampling the original video data.

The tenth determining unit 2203 is configured to: if the target sampling mode is a temporal sampling mode, determine, according to the video perceptual feature, a limited quantity of video frames that correspond to the video data and that are perceived by the target object in unit time; and determine a target sampling rate in the temporal sampling mode according to a ratio of the limited quantity of video frames to a quantity of played video frames, where the quantity of played video frames represents a quantity of video frames that are played in the unit time in the original video data and that are indicated by the video content feature.

The tenth determining unit 2203 is configured to: if the target sampling mode is a spatial sampling mode, determine, according to the video perceptual feature, a limited video resolution associated with the target object; and determine a ratio of the limited video resolution to a video frame resolution as a target sampling rate in the spatial sampling mode, where the video frame resolution represents a video resolution that is of a video frame in the original video data and that is indicated by the video content feature.

The tenth determining unit 2203 is configured to: if the target sampling mode is a temporal sampling mode and a spatial sampling mode, determine, according to the video perceptual feature, a limited quantity of video frames that correspond to video data and that are perceived by the target object in unit time, and determine a limited video resolution associated with the target object; determine a target sampling rate in the temporal sampling mode according to a ratio of the limited quantity of video frames to a quantity of played video frames, where the quantity of played video frames represents a quantity of video frames that are played in the unit time in the original video data and that are indicated by the video content feature; and determine a ratio of the limited video resolution to a video frame resolution as a target sampling rate in the spatial sampling mode, where the video frame resolution represents a video resolution that is of a video frame in the original video data and that is indicated by the video content feature.

The sampling processing module 23 includes: a second obtaining unit 2301, configured to: if the target sampling mode is a temporal sampling mode, obtain a play sequence number of a video frame in the original video data and a total video frame quantity of video frames included in the original video data; a twelfth determining unit 2302, configured to determine, according to a target sampling rate in the temporal sampling mode and the total video frame quantity, a quantity of to-be-extracted video frames in the original video data as a first video frame quantity; and a first extraction unit 2303, configured to extract the first video frame quantity of video frames from the original video data according to the play sequence number of the video frame in the original video data as the sampled video data.

The sampling processing module 23 includes: a third obtaining unit 2304, configured to: if the target sampling mode is a spatial sampling mode, obtain an original video resolution of a video frame Mᵢ in the original video data, where i is a positive integer less than or equal to M, and M is a quantity of video frames in the original video data; a first resolution conversion unit 2305, configured to perform resolution conversion on the video frame Mᵢ having the original video resolution according to a target sampling rate in the spatial sampling mode and the original video resolution of the video frame Mᵢ, to obtain a video frame Mᵢ having a target video resolution; and a thirteenth determining unit 2306, configured to: based on performing resolution sampling on all video frames in the original video data, determine original video data obtained through resolution conversion as the sampled video data.

The first resolution conversion unit 2305 is configured to use a product of the target sampling rate in the spatial sampling mode and the original video resolution of the video frame Mᵢ as an initial video resolution; perform resolution conversion on the video frame Mᵢ having the original video resolution, to obtain a video frame Mᵢ having the initial video resolution; if the video frame Mᵢ having the initial video resolution does not meet an encoding condition, perform pixel padding on the video frame Mᵢ having the initial video resolution, determine a video resolution of a video frame Mᵢ obtained through padding as the target video resolution, and determine the video frame Mᵢ obtained through padding as the video frame Mᵢ having the target video resolution; and if the video frame Mᵢ having the initial video resolution meets the encoding condition, determine the initial video resolution as the target video resolution, and determine the video frame Mᵢ having the initial video resolution as the video frame Mᵢ having the target video resolution.

The sampling processing module 23 includes: a fourteenth determining unit 2307, configured to: if the target sampling mode is a temporal sampling mode and a spatial sampling mode, determine a quantity of to-be-extracted video frames in the original video data as a second video frame quantity according to a target sampling rate in the temporal sampling mode and a total video frame quantity in the original video data; a second extraction unit 2308, configured to extract the second video frame quantity of video frames from the original video data according to a play sequence number of a video frame in the original video data as initial sampled video data; a fourth obtaining unit 2309, configured to obtain an original video resolution of a video frame Nⱼ in the initial sampled video data, where j is a positive integer less than or equal to N, and N is a quantity of video frames in the initial sampled video data; a second resolution conversion unit 2310, configured to perform resolution conversion on the video frame Nⱼ having the original video resolution according to a target sampling rate in the spatial sampling mode and the original video resolution of the video frame Nⱼ, to obtain a video frame Nⱼ having a target video resolution; and a fifteenth determining unit 2311, configured to: based on performing resolution sampling on all video frames in the initial sampled video data, determine initial sampled video data obtained through resolution sampling as the sampled video data.

The video encoding apparatus further includes: the first transmission module 25, configured to transmit the total video frame quantity and the target sampling rate in the temporal sampling mode to a decoding device. The decoding device may be configured to perform sampling restoration on the sampled video data corresponding to the encoded video data according to the total video frame quantity and the target sampling rate in the temporal sampling mode.

The video encoding apparatus further includes: the second transmission module 26, configured to: if the video frame Mᵢ having the target video resolution is obtained through pixel padding, obtain pixel padding location information for pixel padding in the video frame Mᵢ having the target video resolution, and transmit the target sampling rate in the spatial sampling mode and the pixel padding location information to the decoding device, where the decoding device may be configured to perform sampling restoration on the sampled video data corresponding to the encoded video data according to the target sampling rate in the spatial sampling mode and the pixel padding location information; and the third transmission module 27, configured to: if the video frame Mᵢ having the target video resolution is not obtained through pixel padding, transmit the target sampling rate in the spatial sampling mode to the decoding device. The decoding device may be configured to perform sampling restoration on the sampled video data corresponding to the encoded video data according to the target sampling rate in the spatial sampling mode.

The video encoding apparatus further includes: the fourth determining module 28, configured to determine video region information of the original video data; and the fourth transmission module 29, configured to transmit the video region information and the encoded video data to the decoding device. The video region information may be configured for indicating the decoding device to perform image enhancement processing on a video region in the original video data.

The fourth determining module 28 includes: a vector conversion unit 2801, configured to input the original video data into a target detection model, and perform embedding vector conversion on the original video data by using an embedding layer in the target detection model, to obtain a media embedding vector of the original video data; an object extraction unit 2802, configured to perform object extraction on the media embedding vector by using an object extraction layer in the target detection model, to obtain a video object in the original video data; and a second generation unit 2803, configured to determine a region to which the video object belongs in the original video data as the video region, and generate the video region information for describing a location of the video region in the original video data.

According to some embodiments, modules and units in the video encoding apparatus may be separately or wholly combined into one or several units, or one (or more) of the units herein may further be divided into a plurality of subunits of smaller functions. Same operations can be implemented, and implementation of the technical effects of some embodiments is not affected. The foregoing modules are divided based on logical functions. In an actual application, a function of one module may also be implemented by a plurality of units, or functions of a plurality of modules are implemented by one unit. In some embodiments, the video encoding apparatus may also include other units. During actual application, the functions may also be cooperatively implemented by other units and may be cooperatively implemented by a plurality of units.

A person skilled in the art would understand that these “modules” or “units” could be implemented by hardware logic, a processor or processors executing computer software code, or a combination of both. The “modules” or “units” may also be implemented in software stored in a memory of a computer or a non-transitory computer-readable medium, where the instructions of each unit are executable by a processor to thereby cause the processor to perform the respective operations of the corresponding unit.

On an encoding device side, a target sampling parameter of original video data is adaptively determined according to a media application scenario and a video content feature of the original video data, and the original video data is sampled based on the target sampling parameter, to obtain sampled video data, so that accuracy of sampling the original video data can be improved, video viewing quality can be controlled, and redundancy of encoded video data is reduced. Further, the sampled video data is encoded, to obtain encoded video data. The encoded video data may be transmitted to a decoding device, which can reduce a data amount of the encoded video data and improve transmission efficiency of the encoded video data, so that the decoding device can rapidly obtain the encoded video data, and encoding efficiency of the original video data can also be improved.

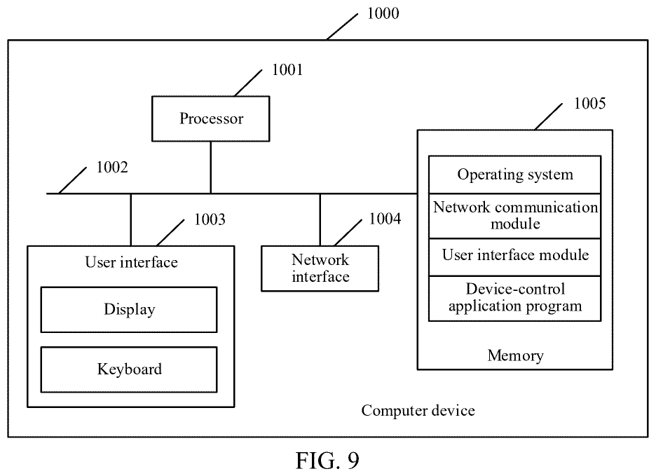

Referring to FIG. 9, FIG. 9 is a schematic structural diagram of a computer device according to some embodiments. As shown in FIG. 9, the computer device 1000 may include: a processor 1001, a network interface 1004, and a memory 1005, as well as a user interface 1003 and at least one communication bus 1002. The communication bus 1002 may be configured to implement connection and communication between the components. The user interface 1003 may include a display, a keyboard, and in some embodiments, the user interface 1003 may further include a standard wired interface and a standard wireless interface. The network interface 1004 may include a standard wired interface and a standard wireless interface (for example, a Wi-Fi interface). The memory 1005 may be a high-speed RAM memory, or may be a non-volatile memory, for example, at least one magnetic disk memory. In some embodiments, the memory 1005 may be at least one storage apparatus that is located far away from the processor 1001. As shown in FIG. 9, the memory 1005 used as a computer-readable storage medium may include an operating system, a network communication module, a user interface module, and a device-control application program.

In the computer device 1000 shown in FIG. 9, the network interface 1004 may provide a network communication function. The user interface 1003 may be configured to provide an input interface for a user. The processor 1001 may be configured to invoke a device-controlled application program stored in the memory 1005, to implement:
obtaining to-be-decoded encoded video data and a target sampling parameter corresponding to the encoded video data, the encoded video data being obtained by encoding sampled video data, the sampled video data being obtained by sampling original video data corresponding to the encoded video data based on the target sampling parameter, the target sampling parameter being determined according to a media application scenario and a video content feature of the original video data; decoding the encoded video data, to obtain the sampled video data; and performing sampling restoration on the sampled video data according to the target sampling parameter, to obtain the original video data corresponding to the encoded video data.

The computer device 1000 described in some embodiments can implement the descriptions of the video decoding method in some embodiments, as illustrated in FIG. 6, and can also implement the descriptions of the video decoding apparatus in some embodiments, as illustrated in FIG. 7.

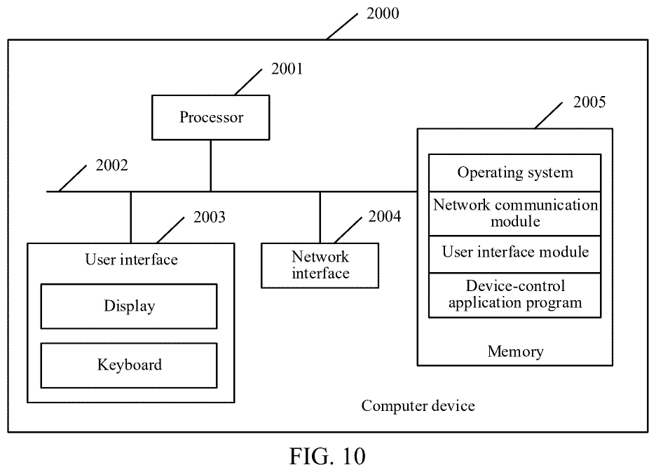

Referring to FIG. 10, FIG. 10 is a schematic structural diagram of a computer device according to some embodiments. As shown in FIG. 10, the computer device 2000 may include: a processor 2001, a network interface 2004, and a memory 2005, as well as a user interface 2003 and at least one communication bus 2002. The communication bus 2002 may be configured to implement connection and communication between the components. The user interface 2003 may include a display, a keyboard, and in some embodiments, the user interface 2003 may further include a standard wired interface and a standard wireless interface. The network interface 2004 may include a standard wired interface and a standard wireless interface (for example, a Wi-Fi interface). The memory 2005 may be a high-speed RAM memory, or may be a non-volatile memory, for example, at least one magnetic disk memory. In some embodiments, the memory 2005 may be at least one storage apparatus that is located far away from the processor 2001. As shown in FIG. 10, the memory 2005 used as a computer-readable storage medium may include an operating system, a network communication module, a user interface module, and a device-control application program.

In the computer device 2000 shown in FIG. 10, the network interface 2004 may provide a network communication function. The user interface 2003 may be configured to provide an input interface for a user. The processor 2001 may be configured to invoke a device-controlled application program stored in the memory 2005, to implement:
obtaining a media application scenario and a video content feature of to-be-encoded original video data; determining, according to the media application scenario and the video content feature, a target sampling parameter for sampling the original video data; sampling the original video data according to the target sampling parameter, to obtain sampled video data; and encoding the sampled video data, to obtain encoded video data corresponding to the original video data.

The computer device 2000 described in some embodiments can implement the descriptions of the video encoding method in some embodiments, as illustrated in FIG. 3, and can also implement the descriptions of the video encoding apparatus in some embodiments, as illustrated in FIG. 8.

In addition, some embodiments provide a computer-readable storage medium. The computer-readable storage medium stores computer-readable instructions executed by the video decoding apparatus according to some embodiments, and the computer-readable instructions include program instructions. When executing the program instructions, a processor can perform the descriptions of the video decoding method in some embodiments, as illustrated in FIG. 6 or the descriptions of the video encoding method in some embodiments, as illustrated in FIG. 3.

Technical details of the method, according to some embodiments, may be applied to the computer-readable storage medium, according to some embodiments. In an example, the program instructions may be deployed to be executed on a computer device, or deployed to be executed on a plurality of computer devices at a same location, or deployed to be executed on a plurality of computer devices that are distributed in a plurality of locations and interconnected through a communication network. The plurality of computer devices that are distributed in the plurality of locations and interconnected through the communication network may form a blockchain system.

In addition, some embodiments provide a computer program product. The computer program product may include computer-readable instructions, and the computer-readable instructions are stored in a computer-readable storage medium. A processor of a computer device reads the computer-readable instructions from the computer-readable storage medium, the processor executes the computer-readable instructions, to cause the computer device to perform the video decoding method in some embodiments, as illustrated in FIG. 6 or perform the video encoding method in some embodiments, as illustrated in FIG. 3.

Although the method, according to some embodiments, is stated as a combination of a series of actions, a person skilled in the art is to know that the disclosure is not limited to the described action sequence. Some operations may be performed in another sequence or simultaneously.

Operations in the method, according to some embodiments, may be adjusted in terms of a sequence or combined.

Merging and division may be performed on the modules in the apparatus in some embodiments.

A person of ordinary skill in the art may understand that all or some of the procedures of the methods in the foregoing embodiments may be implemented by a computer-readable instruction instructing relevant hardware. The program may be stored in a computer-readable storage medium. When the program runs, the procedures of the foregoing method embodiments are performed. The foregoing storage medium may be a magnetic disk, an optical disc, a read-only memory (ROM), a random access memory (RAM), or the like.

The foregoing embodiments are used for describing, instead of limiting the technical solutions of the disclosure. A person of ordinary skill in the art shall understand that although the disclosure has been described in detail with reference to the foregoing embodiments, modifications can be made to the technical solutions described in the foregoing embodiments, or equivalent replacements can be made to some technical features in the technical solutions, provided that such modifications or replacements do not cause the essence of corresponding technical solutions to depart from the spirit and scope of the technical solutions of the embodiments of the disclosure and the appended claims.

What is claimed is:

1. A video encoding method, performed by a computer device, comprising:
obtaining a media application scenario and a video content feature of original video data to be encoded;
determining a target sampling parameter based on the media application scenario and the video content feature;
sampling the original video data based on the target sampling parameter, to obtain sampled video data;
encoding the sampled video data, to obtain encoded video data corresponding to the original video data; and
transmitting at least one of the encoded video data or the target sampling parameter.

2. The method according to claim 1, wherein the determining the target sampling parameter comprises:
determining a target sampling mode based on the video content feature;
determining a video perceptual feature of a target object of the media application scenario;
determining a target sampling rate of the target sampling mode based on the video perceptual feature and the video content feature; and
determining the target sampling rate and the target sampling mode as the target sampling parameter, and
wherein the target object perceives the original video data.

3. The method according to claim 2, wherein the determining the target sampling mode comprises:
determining a repetition rate of video content in the original video data based on a video content change rate of the video content feature; and
determining the target sampling mode based on the repetition rate.

4. The method according to claim 3, wherein the determining the target sampling mode based on the repetition rate comprises at least one of:
based on the repetition rate of the video content being greater than a first threshold, determining a temporal sampling mode and a spatial sampling mode as the target sampling mode;
based on the repetition rate of the video content being less than or equal to the first threshold and greater than a second threshold, determining the temporal sampling mode as the target sampling mode; or
based on the repetition rate of the video content being less than or equal to the second threshold, determining the spatial sampling mode as the target sampling mode, and
wherein the second threshold is less than the first threshold.

5. The method according to claim 2, wherein the determining the target sampling mode comprises:
determining complexity of video content in the original video data based on a video content information amount of the video content feature; and
determining the target sampling mode based on the complexity of the video content.

6. The method according to claim 5, wherein the determining the target sampling mode based on the complexity comprises at least one of:
based on the complexity of the video content being less than a first threshold, determining a temporal sampling mode and a spatial sampling mode as the target sampling mode;
based on the complexity of the video content being greater than or equal to the first threshold and less than a second threshold, determining the spatial sampling mode as the target sampling mode; or
based on the complexity of the video content being greater than the second threshold, determining the temporal sampling mode as the target sampling mode, and
wherein the second threshold is greater than the first threshold

7. The method according to claim 2, wherein the determining the target sampling rate comprises:
based on the target sampling mode being a temporal sampling mode, determining, based on the video perceptual feature, a first quantity of video frames corresponding to the original video data and that are perceived by the target object in unit time; and
determining as the target sampling rate a first target sampling rate of the temporal sampling mode based on a ratio of the first quantity to a second quantity of played video frames, and
wherein the second quantity is a quantity of video frames played in the unit time in the original video data and that are indicated by the video content feature.

8. The method according to claim 2, wherein the determining the target sampling rate comprises:
based on the target sampling mode being a spatial sampling mode, determining, based on the video perceptual feature, a first resolution of the target object; and
determining as the target sampling rate a first target sampling rate of the spatial sampling mode based on a ratio of the first resolution to a second resolution for a video frame, and
wherein the second resolution is a video resolution of a first video frame of the original video data and that is indicated by the video content feature.

9. The method according to claim 2, wherein the determining the target sampling rate comprises:
based on the target sampling mode being a temporal sampling mode and a spatial sampling mode, determining based on the video perceptual feature:
a first quantity of video frames corresponding to the original video data and that are perceived by the target object in unit time, and
a first resolution of the target object;
determining a first target sampling rate of the temporal sampling mode based on a first ratio of the first quantity to a second quantity of played video frames; and
determining a second ratio of the first resolution to a second resolution for a video frame as a second target sampling rate of the spatial sampling mode,
wherein the target sampling rate comprises the first target sampling rate and the second target sampling rate,
wherein the second quantity is a quantity of video frames played in the unit time in the original video data and that are indicated by the video content feature, and
wherein the second resolution is a video resolution of a first video frame of the original video data and that is indicated by the video content feature.

10. The method according to claim 2, wherein the sampling the original video data comprises:
based on the target sampling mode being a temporal sampling mode, obtaining:
a play sequence number of a video frame of the original video data, and
a total video frame quantity of video frames of the original video data;
determining, based on a first target sampling rate of the temporal sampling mode and the total video frame quantity, a first quantity of video frames of the original video data to be extracted; and
extracting the first quantity of video frames from the original video data based on the play sequence number as the sampled video data.

11. A video encoding apparatus, comprising:
at least one memory configured to store computer program code; and
at least one processor configured to read the program code and operate as instructed by the program code, the program code comprising:
obtaining code configured to cause at least one of the at least one processor to obtain a media application scenario and a video content feature of original video data to be encoded;
determining code configured to cause at least one of the at least one processor to determine a target sampling parameter based on the media application scenario and the video content feature;
sampling code configured to cause at least one of the at least one processor to sample the original video data based on the target sampling parameter, to obtain sampled video data;
encoding code configured to cause at least one of the at least one processor to encode the sampled video data, to obtain encoded video data corresponding to the original video data; and
transmitting code configured to cause at least one of the at least one processor to transmit at least one of the encoded video data or the target sampling parameter.

12. The video encoding apparatus according to claim 11, wherein the determining code comprises first determining code, second determining code, third determining code, and fourth determining code,
wherein the first determining code is configured to cause at least one of the at least one processor to determine a target sampling mode based on the video content feature,
wherein the second determining code is configured to cause at least one of the at least one processor to determine a video perceptual feature of a target object of the media application scenario,
wherein the third determining code is configured to cause at least one of the at least one processor to determine a target sampling rate of the target sampling mode based on the video perceptual feature and the video content feature,
wherein the fourth determining code is configured to cause at least one of the at least one processor to determine the target sampling rate and the target sampling mode as the target sampling parameter, and
wherein the target object perceives the original video data.

13. The video encoding apparatus according to claim 12, wherein the determining code further comprises fifth determining code and sixth determining code,
wherein the fifth determining code is configured to cause at least one of the at least one processor to determine a repetition rate of video content in the original video data based on a video content change rate of the video content feature, and
wherein the sixth determining code is configured to cause at least one of the at least one processor to determine the target sampling mode based on the repetition rate.

14. The video encoding apparatus according to claim 13, wherein the sixth determining code comprises at least one of seventh determining code, eighth determining code, or ninth determining code,
wherein the seventh determining code is configured to cause at least one of the at least one processor to, based on the repetition rate of the video content being greater than a first threshold, determine a temporal sampling mode and a spatial sampling mode as the target sampling mode,
wherein the eighth determining code is configured to cause at least one of the at least one processor to, based on the repetition rate of the video content being less than or equal to the first threshold and greater than a second threshold, determine the temporal sampling mode as the target sampling mode,
wherein the ninth determining code is configured to cause at least one of the at least one processor to, based on the repetition rate of the video content being less than or equal to the second threshold, determine the spatial sampling mode as the target sampling mode, and
wherein the second threshold is less than the first threshold.

15. The video encoding apparatus according to claim 12, wherein the first determining code comprises tenth determining code and eleventh determining code,
wherein the tenth determining code is configured to cause at least one of the at least one processor to determine complexity of video content in the original video data based on a video content information amount of the video content feature, and
wherein the eleventh determining code is configured to cause at least one of the at least one processor to determine the target sampling mode based on the complexity of the video content.

16. The video encoding apparatus according to claim 15, wherein the eleventh determining code comprises at least one of twelfth determining code, thirteenth determining code, or fourteenth determining code,
wherein the twelfth determining code is configured to cause at least one of the at least one processor to, based on the complexity of the video content being less than a first threshold, determine a temporal sampling mode and a spatial sampling mode as the target sampling mode,
wherein the thirteenth determining code is configured to cause at least one of the at least one processor to, based on the complexity of the video content being greater than or equal to the first threshold and less than a second threshold, determine the spatial sampling mode as the target sampling mode,
wherein the fourteenth determining code is configured to cause at least one of the at least one processor to, based on the complexity of the video content being greater than the second threshold, determine the temporal sampling mode as the target sampling mode, and
wherein the second threshold is greater than the first threshold

17. The video encoding apparatus according to claim 12, wherein the third determining code is configured to cause at least one of the at least one processor to:
based on the target sampling mode being a temporal sampling mode, determine, based on the video perceptual feature, a first quantity of video frames corresponding to the original video data and that are perceived by the target object in unit time; and
determine as the target sampling rate a first target sampling rate of the temporal sampling mode based on a ratio of the first quantity to a second quantity of played video frames, and
wherein the second quantity is a quantity of video frames played in the unit time in the original video data and that are indicated by the video content feature.

18. The video encoding apparatus according to claim 12, wherein the third determining code is configured to cause at least one of the at least one processor to:
based on the target sampling mode being a spatial sampling mode, determine, based on the video perceptual feature, a first resolution of the target object; and
determine as the target sampling rate a first target sampling rate of the spatial sampling mode based on a ratio of the first resolution to a second resolution for a video frame, and
wherein the second resolution is a video resolution of a first video frame of the original video data and that is indicated by the video content feature.

19. The video encoding apparatus according to claim 12, wherein the third determining code is configured to cause at least one of the at least one processor to:
based on the target sampling mode being a temporal sampling mode and a spatial sampling mode, determine based on the video perceptual feature:
a first quantity of video frames corresponding to the original video data and that are perceived by the target object in unit time, and
a first resolution of the target object;
determine a first target sampling rate of the temporal sampling mode based on a first ratio of the first quantity to a second quantity of played video frames; and
determine a second ratio of the first resolution to a second resolution for a video frame as a second target sampling rate of the spatial sampling mode,
wherein the target sampling rate comprises the first target sampling rate and the second target sampling rate,
wherein the second quantity is a quantity of video frames played in the unit time in the original video data and that are indicated by the video content feature, and
wherein the second resolution is a video resolution of a first video frame of the original video data and that is indicated by the video content feature.

20. A non-transitory computer-readable storage medium, storing computer code which, when executed by at least one processor, causes the at least one processor to at least:
obtain a media application scenario and a video content feature of original video data to be encoded;
determine a target sampling parameter based on the media application scenario and the video content feature;
sample the original video data based on the target sampling parameter, to obtain sampled video data;
encode the sampled video data, to obtain encoded video data corresponding to the original video data; and
transmit at least one of the encoded video data or the target sampling parameter.
